(19) United States
(12) Patent Application Publication
(10) Pub. No.: US 2025/0197781 A1
(43) Pub. Date: Jun. 19, 2025

(54) LAUNDRY TREATMENT COMPOSITON COMPRISING A DELIVERY PARTICLE

(71) Applicant: The Procter & Gamble Company, Cincinnati, OH (US)

(72) Inventors: Eduard Andres CAICEDO CASSO, Maineville, OH (US); Mattia COLLU, Saint-Gilles (BE); Zoe DYTER, Newcastle upon Tyne (GB); Julien Christian LABIE, Waterloo (BE); Laura ORLANDINI, Le Mont-sur-Lausanne (CH); Pieter Jan Maria SAVEYN, Destelbergen (BE); Johan SMETS, Lubbeek (BE); Cédric Marc TAHON, Gent (BE); Pierre Daniel VERSTRAETE, Woluwe Saint Lambert (BE); Wouter WALRAVENS, Humbeek (BE); Travis Ian BARDSLEY, Appleton, WI (US); Sonia Marcela MALAGON GOMEZ, Appleton, WI (US); Linsheng FENG, Menasha, WI (US); Dominick Joseph VALENTI, Moore, SC (US)

(21) Appl. No.: 18/978,493

(22) Filed: Dec. 12, 2024

Related U.S. Application Data
(60) Provisional application No. 63/609,378, filed on Dec. 13, 2023.

(51) Int. Cl. C11D 3/50; C11D 1/14; C11D 1/22; C11D 1/29; C11D 1/62; C11D 1/72; C11D 1/75; C11D 1/86; C11D 3/37; C11D 17/00; C11D 17/04

(52) U.S. Cl. CPC C11D 3/505; C11D 1/86; C11D 3/3726; C11D 17/0039; C11D 17/043; C11D 17/044; C11D 1/146; C11D 1/22; C11D 1/29; C11D 1/62; C11D 1/72; C11D 1/75

(57) ABSTRACT

A laundry treatment composition includes a delivery particle. The delivery particle includes a core and shell surrounding the core, and the core includes a perfume and the shell includes a polymeric material that is the reaction product of chitosan. The reaction product of chitosan is derived from an aqueous phase and a cross-linking agent. The cross-linking agent includes an isocyanate component, the isocyanate component including a mixture of two or more di- and/or poly-isocyanates, derived from an oil phase, the di- and/or poly-isocyanates each including an aromatic moiety; and the mixture of di- and/or poly-isocyanates including an aromatic moiety includes at least one alpha-aromatic isocyanate and at least one beta-aromatic isocyanate.

### TECHNICAL FIELD

The present disclosure relates to laundry treatment compositions wherein the laundry treatment composition comprises a delivery particle.

### BACKGROUND

Laundry treatment compositions are well known and used by consumers to clean, soften or otherwise treat fabrics during the laundry operation.

One of the benefits desired by consumers is that once laundered, fabrics should remain smelling fresh for longer periods of time. This is achieved by depositing perfumes onto the fabrics during the wash operation. Such perfumes comprise perfume raw materials which provide the distinctive scent on the fabrics desired by consumers. Delivery particles are known for increasing the longevity of perfumes on fabrics and for aiding in the deposition of perfume onto fabrics during the wash.

Without wishing to be bound by theory, a delivery particle comprises a shell and a core, wherein the core comprises the perfume. The shell can be made from various technologies. However, one technology is the combination of a reaction product of chitosan and a cross-linking agent, wherein the cross-linking agent comprises an isocyanate component. Whilst such delivery particles are well suited for delivering perfumes through the wash operation on fabrics, it was found that when formulated into certain laundry treatment compositions, there was lower than desired consumer noticeable freshness benefits on fabrics following the wash operation. Without wishing to be bound by theory, it was found that when the prior art delivery particles were formulated into certain laundry treatment composition, there resulted an unacceptable level of perfume leakage from the particle. This resulted in lower than desired levels of perfume being delivered to the fabric through the wash operation and so resulting in lower than desired consumer noticeable freshness benefits on fabrics following the wash operation.

It was surprisingly found that by incorporating a mixture of di- and/or poly-isocyanates comprises at least one alpha-aromatic isocyanate and at least one beta-aromatic isocyanate in the shell resulted in delivery particles that exhibited consumer acceptable freshness benefits on fabrics when said fabrics were treated through the wash when using all the different laundry treatment compositions comprising delivery particles according to the present disclosure.

### SUMMARY

The present disclosure related to a laundry treatment composition comprising a delivery particle wherein the delivery particle comprises a core and shell surrounding the core, and wherein the core comprises a perfume, wherein the shell comprises a polymeric material that is the reaction product of chitosan wherein the reaction product of chitosan is derived from an aqueous phase, and a cross-linking agent, wherein the cross-linking agent comprises an isocyanate component, the isocyanate component comprising a mixture of two or more di- and/or poly-isocyanates, derived from an oil phase, the di- and/or poly-isocyanates each comprising an aromatic moiety; and, wherein the mixture of di- and/or poly-isocyanates comprising an aromatic moiety comprises at least one alpha-aromatic isocyanate and at least one beta-aromatic isocyanate.

### DETAILED DESCRIPTION

### Laundry Treatment Composition

The present disclosure is a laundry treatment composition comprising a delivery particle. The delivery particle is described in more detail below.

The laundry treatment composition is used to treat fabrics in a wash operation. Such a wash operation may be an automatic wash operation, a manual wash operation or a mixture thereof. An automatic wash operation can be conducted in an automatic washing machine, wherein said washing machine may be a top loading machine or a front loading machine. Those skilled in the art will be aware of suitable wash operations and machines. The water in the wash operation may be at a temperature from 10° C. to 90° C., or from 15° C. to 40° C. The treatment composition is mixed with water to create a wash liquor and fabrics are contacted with the wash liquor the fabrics. The wash liquor may be created and then fabrics added or the wash liquor may be created around the fabrics, for example, the fabrics may be present in the drum of the washing machine and water and treatment composition added to those fabrics to create the wash liquor.

The treatment composition may be a laundry detergent composition, a laundry enhancer composition, a laundry fragrance boosting composition or a mixture thereof.

The treatment composition may be a liquid, a gel, a powder, or a mixture thereof. The treatment composition may be in the form of a unitized dose, wherein the unitized dose could be a unit dose article comprising one or more chambers defined by a water-soluble film or a water-soluble non-woven and in which the laundry treatment composition is contained within said one of more chambers, or wherein the unit dose article is in the form of a non-woven article comprising a plurality of fibers and wherein the laundry treatment composition is contained within and/or between the fibers. The laundry treatment composition may be a fabric enhancer bead. The laundry treatment composition may be in the form of a solid dissolvable composition.

Suitable laundry detergent compositions include laundry detergent granular compositions, laundry beads, laundry detergent liquid compositions, laundry detergent gel compositions, laundry sheets, fibrous articles and water-soluble unit dose laundry detergent compositions. Suitable laundry fabric enhancers are liquid fabric enhancers including compact liquid fabric enhancers, and solid fabric enhancers including fabric enhancer beads and sheets.

A granular composition comprises a plurality of granules. The granules may be spray dried, agglomerated, extruded or a mixture thereof. Typically, the granular laundry detergent composition is a fully formulated laundry detergent composition, not a portion thereof such as a spray-dried, extruded or agglomerate granule that only forms part of the laundry detergent composition. Typically, the granular detergent composition comprises a plurality of chemically different granules, such as spray-dried base detergent granules and/or agglomerated base detergent granules and/or extruded base detergent granules, in combination with one or more, typically two or more, or five or more, or even ten or more granules selected from: surfactant granules, including surfactant agglomerates, surfactant extrudates, surfactant needles, surfactant noodles, surfactant flakes; phosphate granules; zeolite granules; silicate salt granules, especially sodium silicate granules; carbonate salt granules, especially sodium carbonate granules; polymer granules such as carboxylate polymer granules, cellulosic polymer granules, starch granules, polyester granules, polyamine granules, terephthalate polymer granules, polyethylene glycol granules; aesthetic garnules such as coloured noodles, needles, lamellac granules and ring granules; enzyme granules such as protease granulates, amylase granulates, lipase granulates, cellulase granulates, mannanase granulates, pectate lyase granulates, xyloglucanase granulates, bleaching enzyme granulates and co-granulates of any of these enzymes, preferably these enzyme granulates comprise sodium sulphate; bleach particles, such as percarbonate granules, especially coated percarbonate granules, such as percarbonate coated with carbonate salt, sulphate salt, silicate salt, borosilicate salt, or any combination thereof, perborate granules, bleach activator granules such as tetra acetyl ethylene diamine granules and/or alkyl oxybenzene sulphonate granules, bleach catalyst granules such as transition metal catalyst granules, and/or isoquinolinium bleach catalyst granules, pre-formed peracid granules, especially coated pre-formed peracid granules; filler granules such as sulphate salt granules and chloride granules; clay granules such as montmorillonite granules and granules of clay and silicone; flocculant granules such as polyethylene oxide granules; wax granules such as wax agglomerates; silicone granules, brightener granules; dye transfer inhibition granules; dye fixative granules; starch encapsulated perfume accord particles, or pro-perfume particles such as Schiff base reaction product particles; hucing dye granules; chelant granules such as chelant agglomerates; and any combination thereof.

Suitable granular laundry detergent compositions may have a low buffering capacity. Such laundry detergent compositions typically have a reserve alkalinity to pH 9.5 of less than 5.0 gNaOH/100 g. These low buffered laundry detergent compositions typically comprise low levels of carbonate salt.

Preferably, the delivery particles according to the present disclosure are formulated into a granule. The granule comprising the delivery particles may be a spray dried particle.

The laundry treatment composition may be a liquid laundry treatment composition. The laundry treatment composition may be a liquid laundry detergent composition.

The laundry treatment composition, or even the liquid laundry detergent composition can have a pH of from 2 to 11, or from 6.5 to 8.9, or from 7 to 8, wherein the pH of the laundry treatment composition is measured at a 10% product concentration in demineralized water at 20° C.

The liquid laundry treatment composition can be Newtonian or non-Newtonian, preferably non-Newtonian.

For liquid laundry treatment compositions, the composition can comprise from 5% to 99%, or from 15% to 90%, or from 25% to 80% by weight of the liquid detergent composition of water.

As used herein, the phrases “water-soluble unit dose article,” “water-soluble fibrous structure”, and “water-soluble fibrous element” mean that the unit dose article, fibrous structure, and fibrous element are miscible in water. In other words, the unit dose article, fibrous structure, or fibrous element is capable of forming a homogeneous solution with water at ambient conditions. “Ambient conditions” as used herein means 23° C.±1.0° C. and a relative humidity of 50%±2%. The water-soluble unit dose article may contain insoluble materials, which are dispersible in aqueous wash conditions to a suspension mean particle size that is less than about 20 microns, or less than about 50 microns.

The laundry treatment composition can be a water-soluble unit dose article. The water-soluble unit dose article may comprise at least one water-soluble film orientated to create at least one unit dose internal compartment, wherein the at least one unit dose internal compartment comprises the laundry treatment composition, preferably a liquid laundry treatment composition. The water-soluble film preferably comprises polyvinyl alcohol homopolymer or polyvinyl alcohol copolymer, for example a blend of polyvinylalcohol homopolymers and/or polyvinylalcohol copolymers, for example copolymers selected from sulphonated and carboxylated anionic polyvinylalcohol copolymers especially carboxylated anionic polyvinylalcohol copolymers, for example a blend of a polyvinylalcohol homopolymer and a carboxylated anionic polyvinylalcohol copolymer. In some examples water-soluble films are those supplied by Monosol under the trade references M8630, M8900, M8779, M8310. Preferably the liquid laundry treatment composition within the at least one unit dose internal compartment comprises less than 15%, or less than 12% by weight of the liquid laundry treatment composition of water. Preferably, the liquid laundry treatment composition within the at least one unit dose internal compartment comprises between 10% and 40%, or between 15% and 30% by weight of the liquid laundry detergent composition of a non-aqueous solvent selected from 1,2-propanediol, dipropylene glycol, tripropyleneglycol, glycerol, sorbitol, polyethylene glycol or a mixture thereof. Preferably, the liquid laundry treatment composition within the at least one unit dose internal compartment has a pH between 6 and 10, between 6.5 and 8.9, or between 7 and 8, wherein the pH of the liquid laundry treatment composition is measured as a 10% product concentration in demineralized water at 20° C.

When liquid, the liquid laundry treatment composition within the at least one unit dose internal compartment may be Newtonian or non-Newtonian, preferably non-Newtonian.

The laundry treatment composition may be in the form of a fibrous water-soluble unit dose article. The fibrous water-soluble unit dose articles disclosed herein comprise a water-soluble fibrous structure and one or more particles. The water-soluble fibrous structure may comprise a plurality of fibrous elements, for example a plurality of filaments. The one or more particles, for example one or more active agent-containing particles, may be distributed throughout the structure. The water-soluble unit dose article may comprise a plurality of two or more and/or three or more fibrous elements that are inter-entangled or otherwise associated with one another to form a fibrous structure and one or more particles, which may be distributed throughout the fibrous structure. The delivery particle according to the present disclosure are distributed through the structure.

The fibrous water-soluble unit dose article described herein may comprise a water-soluble fibrous structure and one or more rheology-modified particles comprising: (a) from about 10 wt to about 80 wt % of an alkylalkoxylated sulfate; and (b) from about 0.5 wt % to about 20 wt % of a rheology modifier. The particles described herein may comprise one or more additional active agents (in addition to surfactant as described hereinabove).

The water-soluble fibrous structure may be shaped to form a sealed internal compartment, wherein the laundry treatment composition is comprised within said internal compartment. In such a form the laundry treatment composition is in the form of a granular laundry treatment composition as described above.

The fibrous water-soluble unit dose articles as described above comprise a water-soluble fibrous non-woven sheet. The water-soluble fibrous non-woven sheet comprises a plurality of fibers. Preferably, the fibers are inter-entangled fibers in the form of a fibrous structure.

The water-soluble fibrous non-woven sheet may be homogeneous or may be layered. If layered, the water-soluble fibrous non-woven sheet may comprise at least two and/or at least three and/or at least four and/or at least five layers.

Preferably, the water-soluble fibrous non-woven sheet has a basis weight of between 20 gsm and 60 gsm, preferably between 20 gsm and 55 gsm, more preferably between 25 gsm and 50 gsm, most preferably between 25 gsm and 45 gsm. Those skilled in the art will be aware of methods to measure the basis weight.

By ‘fiber’ we herein mean an elongated element having a length exceeding its average diameter, preferably, a length to average diameter ratio of at least about 10.

Preferably, each fiber may have a length of greater than or equal to 5.08 cm, greater than or equal to 7.62 cm, greater than or equal to 10.16, greater than or equal to 15.24 cm or a mixture thereof.

Alternatively, each fiber may have length of less than 5.08 cm, less than 3.81 cm, less than 2.54 cm, or a mixture thereof.

Each fiber may have a width of less than 100 μm, less than 75 μm, less than 50 μm, less than 25 μm, less than 10 μm, less than 5 μm, less than 1 μm or a mixture thereof. Those skilled in the art will be aware of standard methods and techniques to measure the width. Preferred methods include Scanning Electron Microscope (SEM) or an Optical Microscope together with image analysis software.

The water-soluble fibrous non-woven sheet may comprise a plurality of identical or substantially identical, from a compositional perspective, fibers. Alternatively, the water-soluble fibrous non-woven sheet may comprise two or more different fibers according to the present disclosure. Non-limiting examples of differences in the fibers may be physical differences such as differences in diameter, length, texture, shape, rigidness, elasticity, and the like; chemical differences such as crosslinking level, solubility, melting point, Tg, active agent.

Preferably, the fibers are present between 80% and 95%, preferably between 85% and 93%, more preferably between 87% and 90% by weight of the water-soluble fibrous non-woven sheet.

The water-soluble fibrous non-woven sheet may exhibit different regions, such as different regions of basis weight, density, and/or caliper. The water-soluble fibrous non-woven sheet may comprise texture on one or more of its surfaces. A surface of the water-soluble fibrous non-woven sheet may comprise a pattern, such as a non-random, repeating pattern.

The water-soluble fibrous non-woven sheet may have a thickness between 0.01 mm and 100 mm, preferably between 0.05 mm and 50 mm, more preferably between 0.1 mm and 20 mm, even more preferably between 0.1 mm and 10 mm, even more preferably between 0.1 mm and 5 mm, even more preferably between 0.1 mm and 2 mm, even more preferably between 0.1 mm and 0.5 mm, most preferably between 0.1 mm and 0.3 mm. Those skilled in the art will be aware of standard methods to measure the thickness.

The fibers may comprise a polyvinyl alcohol polymer. Preferably, the fibers comprise between 50% and 98%, preferably between 65% and 97%, more preferably between 80% and 96%, even more preferably between 88% and 96% by weight of the fiber of polyvinyl alcohol.

The polyvinyl alcohol polymer may have a weight average molecular weight of between 50 kDa and 150 kDa, preferably between 75 kDa and 140 kDa, more preferably between 100 kDa and 130 kDa. “Weight average molecular weight” as used herein means the weight average molecular weight as determined using gel permeation chromatography according to the protocol found in Colloids and Surfaces A. Physico Chemical & Engineering Aspects, Vol. 162, 2000, pg. 107-121. Those skilled in the art will be aware of other known techniques to determine the weight average molecular weight (MW).

Preferably, the polyvinyl alcohol polymer is a polyvinyl alcohol homopolymer. Preferably, the polyvinyl alcohol homopolymer has an average percentage degree of hydrolysis of from 75% to 100%, preferably of from 80% to 95%, most preferably of from 85% to 90%. Preferably, the polyvinyl alcohol homopolymer has an average viscosity of from 1 to 30 mPas, preferably from 5 to 25 mPas, most preferably from 10 to 20 mPas, wherein the viscosity is measured as a 4% aqueous solution in demineralized water at 20° C.

The fibers preferably comprise between 0.1% and 15% by weight of the fibers of a gel-breaker, wherein the gel-breaker is selected from polyols, sugar alcohols, amines, amides, carbohydrates, multivalent cations, or a mixture thereof, preferably polyols, sugar alcohols or a mixture thereof. Preferably, the fibers comprise between 1% and 12%, preferably between 2% and 10% by weight of the fibers of the gel-breaker.

The unit dose article may comprise a first fibrous non-woven sheet and a second water-soluble fibrous non-woven sheet sealed to one another such to define the internal compartment. The unit dose article may comprise more than one compartment, even at least two compartments, or even at least three compartments. The compartments may be positioned in a side-by-side orientation, i.e. one orientated next to the other. Alternatively, one compartment may be completely enclosed within another compartment.

In any of the above examples of water-soluble unit dose forms, wherein the unit dose article comprises at least two compartments, one of the compartments may be smaller than the other compartment.

In any of the above examples of water-soluble unit dose forms, each compartment may comprise the same or different compositions.

The laundry treatment composition may be in the form of a water-soluble porous flexible solid sheet. The water-soluble porous flexible solid sheet may comprise a water-soluble polymer, a surfactant, and the delivery particle according to the present disclosure wherein said solid sheet article has opposing first and second planar surfaces; wherein the delivery particle is located between said opposing first and second planar surfaces. The solid sheet article may be characterized by a percent Open Cell Content of from 85% to 99%, preferably from 90% to 98%; and/or an Overall Average Pore Size of from 150 μm to 1000 μm, preferably from 200 μm to 600 μm; and/or an Average Cell Wall Thickness of from 5 μm to 200 μm, preferably from 10 μm to 100 μm, more preferably from 10 μm to 80 μm; and/or a final moisture content of from 0.5% to 25%, preferably from 1% to 20%, more preferably from 3% to 10%, by weight of said solid sheet article; and/or a thickness of from 0.5 mm to 4 mm, preferably from 0.6 mm to 3.5 mm, more preferably from 0.7 mm to 3 mm, still more preferably from 0.8 mm to 2 mm, most preferably from 1 mm to 2 mm; and/or a basis weight of from 50 grams/m² to 500 grams/m², preferably from 150 grams/m² to 450 grams/m², more preferably from 250 grams/m² to 400 grams/m²; and/or a density of from 0.05 grams/cm³ to 0.5 grams/cm³, preferably from 0.06 grams/cm³ to 0.4 grams/cm³, more preferably from 0.07 grams/cm³ to 0.2 grams/cm³, most preferably from 0.08 grams/cm³ to 0.15 grams/cm³; and/or a Specific Surface Area of from 0.03 m²/g to 0.25 m²/g, preferably from 0.04 m²/g to 0.22 m²/g, more preferably from 0.05 m²/g to 0.2 m²/g, most preferably from 0.1 m²/g to 0.18 m²/g.

The solid sheet may optionally comprise other adjunct ingredients.

The laundry treatment composition may be in the form of a fabric enhancer bead. Said fabric enhancer beads may comprise a water-soluble carrier. The water-soluble carrier acts to carry the delivery particle to the wash liquor. Upon dissolution of the water-soluble carrier, the delivery particle is dispersed into the wash liquor and deposited onto the laundry.

The water-soluble carrier can be a material that is soluble in a wash liquor within a short period of time, for instance less than about 10 minutes.

The water-soluble carrier can be selected from the group consisting of water-soluble inorganic alkali metal salt, water-soluble alkaline earth metal salt, water-soluble organic alkali metal salt, water-soluble organic alkaline earth metal salt, water-soluble carbohydrate (monosaccharide, disaccharide, and/or polysaccharide), water-soluble silicate, water-soluble urea, and any combination thereof.

The water-soluble carrier can be selected from the group consisting of polyethylene glycol, sodium acetate, sodium bicarbonate, sodium chloride, sodium silicate, polypropylene glycol polyoxoalkylene, polyethylene glycol fatty acid ester, polyethylene glycol ether, sodium sulfate, magnesium sulfate, starch, and mixtures thereof. In one embodiment, the water-soluble carrier can be sodium chloride. In one embodiment, the water-soluble carrier can be table salt.

The water-soluble carrier can be a water-soluble polymer. The water-soluble polymer can be selected from the group consisting of C8-C22 alkyl polyalkoxylate comprising more than about 40 alkoxylate units, ethoxylated nonionic surfactant having a degree of ethoxylation greater than about 30, polyalkylene glycol having a weight average molecular weight from about 2000 to about 15000, and combinations thereof.

The water-soluble polymer can be polyethylene glycol (PEG). The fabric enhancer beads can comprise about 25% to about 94% by weight PEG having a weight average molecular weight from about 2000 to about 15000. A suitable weight average molecular weight range of PEG includes from about 2,000 to about 13,000, alternatively from about 4,000 to about 13,000, alternatively from about 4,000 to about 12,000, alternatively from about 4,000 to about 11,000, alternatively from about 5,000 to about 11,000, alternatively from about 6,000 to about 10,000, alternatively from about 7,000 to about 9,000, alternatively combinations thereof. PEG is available from BASF, for example PLURIOL E 8000, or other PLURIOL product.

The fabric enhancer beads can comprise about 25% to about 99% by weight water-soluble carrier. The fabric enhancer beads can comprise from about 35% to about 95%, optionally from about 50% to about 80%, optionally combinations thereof and any whole percentages or ranges of whole percentages within any of the aforementioned ranges, of water-soluble carrier by weight of the fabric enhancer beads.

The laundry treatment composition may be in the form of a solid dissolvable composition. Solid dissolvable compositions (SDC) comprise crystallizing agent, water, and an active agent. The crystallizing agent primarily consists of sodium salt of saturated fatty acids having from 8 to 12 methylene groups, where the sodium counter ion enables formation of fiber crystal mesh (counter ions other than sodium result in non-fiber crystals) in the composition and where an intentional blend of 8 to 12 methylene groups enables dissolution at different times over a range of washer conditions, including temperature, to maximize the consumer benefit. The water composition is preferably less than about 10 wt. % of the SDC and more preferably less than 5 wt. %. The fiber crystals incorporate about 3-5 wt. % water into the crystal structure. The active agent is used to treat fabrics and is added during making (Mixing) or after preparation of the composition (Drying), where the active agents may include neat perfumes and the delivery particle according to the present disclosure.

The solid dissolvable compositions comprise fibrous interlocking crystals with sufficient crystal fiber length and concentration to form a mesh microstructure. The mesh allows the SDC to be solid, with a relatively small amount of material. The mesh also allows the entrapment and protection of particulate active agents, such the delivery particle according to the present disclosure. The voids in the mesh microstructure allows very high levels of active agent inclusion. It is possible to add up to about 15 wt. % active agent, preferably between about 15 wt. % and about 0.01%, preferably between about 13 wt. % and about 0.5 wt. %, preferably between about 13 wt. % and about 2 wt. %, most preferably between about 10 wt. % and about 2 wt. %. The voids also provide a pathway for water to entrain into the microstructure during washing to speed the dissolution relative to completely solid compositions.

The laundry treatment composition may comprise;
a. less than 20% or even less than 15% by weight of the composition of water;
b. between 15% and 70%, or even between 20% and 65% by weight of the composition of a surfactant, wherein preferably the surfactant is selected from an anionic surfactant, a non-ionic surfactant, a cationic surfactant or a mixture thereof.;
c. or a mixture thereof.

Without wishing to be bound by theory, it is believed that conditions of low water and/or high surfactant may contribute the increase perfume leakage seen from the delivery particle according to the prior art. Surprisingly, it was found that the delivery particle according to the present disclosure exhibited reduced leakage in such low water and/or high surfactant environments, making it suitable for use in a wide range of laundry treatment composition forms. The reduced leakage resulted in consumer-acceptable levels of freshness on fabrics laundered using the fabric treatment composition according to the present disclosure.

### Surfactant

The laundry treatment compositions may comprise a surfactant in an amount sufficient to provide desired cleaning properties. The laundry treatment composition may comprise, by weight of the composition, from about 1% to about 70% of a surfactant. Alternatively, the laundry treatment composition may comprise, by weight of the laundry treatment composition, from about 2% to about 60% of the surfactant. Alternatively, the laundry treatment composition may comprise=s, by weight of the composition, from about 5% to about 30% of the surfactant The surfactant may comprise a laundry treatment surfactant selected from anionic surfactants, nonionic surfactants, cationic surfactants, zwitterionic surfactants, amphoteric surfactants, ampholytic surfactants, and mixtures thereof. Those of ordinary skill in the art will understand that a laundry treatment surfactant encompasses any surfactant or mixture of surfactants that provide cleaning, stain removing, softening or laundering benefit to fabric being laundered.

Suitable surfactants may be linear or branched, substituted or un-substituted, and may be derived from petrochemical material or biomaterial. Preferred surfactant systems comprise both anionic and nonionic surfactant, preferably in weight ratios from 90:1 to 1:90. In some instances a weight ratio of anionic to nonionic surfactant of at least 1:1 is preferred. However, a ratio below 10:1 may be preferred.

Anionic Surfactant: Anionic surfactants include, but are not limited to, those surface-active compounds that contain an organic hydrophobic group containing generally 8 to 22 carbon atoms or generally 8 to 18 carbon atoms in their molecular structure and at least one water-solubilizing group preferably selected from sulfonate, sulfate, and carboxylate so as to form a water-soluble compound. Usually, the hydrophobic group will comprise a C₈-C₂₂ alkyl, or acyl group. Such surfactants are employed in the form of water-soluble salts and the salt-forming cation usually is selected from sodium, potassium, ammonium, magnesium and mono-, with the sodium cation being the usual one chosen.

Anionic surfactants of the present disclosure and adjunct anionic cosurfactants, may exist in an acid form, and said acid form may be neutralized to form a surfactant salt which is desirable for use in the present detergent compositions. Typical agents for neutralization include the metal counterion base such as hydroxides, e.g., NaOH or KOH. Further preferred agents for neutralizing anionic surfactants of the present disclosure and adjunct anionic surfactants or cosurfactants in their acid forms include ammonia, amines, oligamines, or alkanolamines. Alkanolamines are preferred. Suitable non-limiting examples including monocthanolamine, dicthanolamine, triethanolamine, and other linear or branched alkanolamines known in the art; for example, highly preferred alkanolamines include 2-amino-1-propanol, 1-aminopropanol, monoisopropanolamine, or 1-amino-3-propanol. Amine neutralization may be done to a full or partial extent, e.g. part of the anionic surfactant mix may be neutralized with sodium or potassium and part of the anionic surfactant mix may be neutralized with amines or alkanolamines.

Suitable sulphonate surfactants include methyl ester sulphonates, alpha olefin sulphonates, alkyl benzene sulphonates, especially alkyl benzene sulphonates, preferably C₁₀-C₁₃ alkyl benzene sulphonate. Suitable alkyl benzene sulphonate (LAS) is obtainable, preferably obtained, by sulphonating commercially available linear alkyl benzene (LAB). Suitable LAB includes low 2-phenyl LAB, such as those supplied by Sasol under the tradename Isochem® or those supplied by Petresa under the tradename Petrelab®, other suitable LAB include high 2-phenyl LAB, such as those supplied by Sasol under the tradename Hyblene®. A suitable anionic surfactant is alkyl benzene sulphonate that is obtained by DETAL catalyzed process, although other synthesis routes, such as HF, may also be suitable. In one aspect a magnesium salt of LAS is used.

Preferably, the laundry treatment composition may contain from about 0.5% to about 30%, by weight of the laundry treatment composition, of an HLAS surfactant selected from alkyl benzene sulfonic acids, alkali metal or amine salts of C₁₀-C₁₆ alkyl benzene sulfonic acids, wherein the HLAS surfactant comprises greater than 50% C₁₂, preferably greater than 60%, preferably greater than 70% C₁₂, more preferably greater than 75%

Suitable sulphate surfactants include alkyl sulphate, preferably C₈-18 alkyl sulphate, or predominantly C₁₂ alkyl sulphate.

A preferred sulphate surfactant is alkyl alkoxylated sulphate, preferably alkyl ethoxylated sulphate, preferably a C₈-C₁₈ alkyl alkoxylated sulphate, preferably a C₈-C₁₈ alkyl cthoxylated sulphate, preferably the alkyl alkoxylated sulphate has an average degree of alkoxylation of from 0.5 to 20, preferably from 0.5 to 10, preferably the alkyl alkoxylated sulphate is a C₈-C₁₈ alkyl ethoxylated sulphate having an average degree of cthoxylation of from 0.5 to 10, preferably from 0.5 to 5, more preferably from 0.5 to 3 or from about 1.5 to 3 or from about 1.8 to 2.5. The alkyl alkoxylated sulfate may have a broad alkoxy distribution or a peaked alkoxy distribution. The alkyl portion of the AES may include, on average, from 13.7 to about 16 or from 13.9 to 14.6 carbons atoms. At least about 50% or at least about 60% of the AES molecule may include having an alkyl portion having 14 or more carbon atoms, preferable from 14 to 18, or from 14 to 17, or from 14 to 16, or from 14 to 15 carbon atoms.

The alkyl sulphate, alkyl alkoxylated sulphate and alkyl benzene sulphonates may be linear or branched, including 2 alkyl substituted or mid chain branched type, substituted or un-substituted, and may be derived from petrochemical material or biomaterial. Preferably, the branching group is an alkyl. Typically, the alkyl is selected from methyl, ethyl, propyl, butyl, pentyl, cyclic alkyl groups and mixtures thereof. Single or multiple alkyl branches could be present on the main hydrocarbyl chain of the starting alcohol(s) used to produce the sulfated anionic surfactant used in the detergent of the present disclosure. Most preferably the branched sulfated anionic surfactant is selected from alkyl sulfates, alkyl ethoxy sulfates, and mixtures thereof.

Alkyl sulfates and alkyl alkoxy sulfates are commercially available with a variety of chain lengths, ethoxylation and branching degrees. Commercially available sulfates include those based on Neodol alcohols ex the Shell company, Lial-Isalchem and Safol ex the Sasol company, natural alcohols ex The Procter & Gamble Chemicals company.

Other suitable anionic surfactants include alkyl ether carboxylates, comprising a C₁₀-C₂₆ linear or branched, preferably C₁₀-C₂₀ linear, most preferably C₁₆-C₁₈ linear alkyl alcohol and from 2 to 20, preferably 7 to 13, more preferably 8 to 12, most preferably 9.5 to 10.5 ethoxylates. The acid form or salt form, such as sodium or ammonium salt, may be used, and the alkyl chain may contain one cis or trans double bond. Alkyl ether carboxylic acids are available from Kao (Akypo®), Huntsman (Empicol®) and Clariant (Emulsogen®).

Other suitable anionic surfactants are rhamnolipids. The rhamnolipids may have a single rhamnose sugar ring or two rhamnose sugar rings.

Non-ionic Surfactant: Suitable non-ionic surfactants are selected from the group consisting of: C₈-C₁₈ alkyl ethoxylates, such as, NEODOL® non-ionic surfactants from Shell; C₆-C₁₂ alkyl phenol alkoxylates wherein preferably the alkoxylate units are ethyleneoxy units, propyleneoxy units or a mixture thereof; C₁₂-Cis alcohol and C₆-C₁₂ alkyl phenol condensates with ethylene oxide/propylene oxide block polymers such as Pluronic® from BASF; alkylpolysaccharides, preferably alkylpolyglycosides; methyl ester ethoxylates; polyhydroxy fatty acid amides; ether capped poly(oxyalkylated) alcohol surfactants; and mixtures thereof.

Suitable non-ionic surfactants are alkylpolyglucoside and/or an alkyl alkoxylated alcohol.

Suitable non-ionic surfactants include alkyl alkoxylated alcohols, preferably C₈-C₁₈ alkyl alkoxylated alcohol, preferably a C₈-C₁₈ alkyl ethoxylated alcohol, preferably the alkyl alkoxylated alcohol has an average degree of alkoxylation of from 1 to 50, preferably from 1 to 30, or from 1 to 20, or from 1 to 10, preferably the alkyl alkoxylated alcohol is a C₈-C₁₈ alkyl ethoxylated alcohol having an average degree of ethoxylation of from 1 to 10, preferably from 1 to 7, more preferably from 1 to 5 and most preferably from 3 to 7. In one aspect, the alkyl alkoxylated alcohol is a C₁₂-Cis alkyl ethoxylated alcohol having an average degree of ethoxylation of from 7 to 10. The alkyl alkoxylated alcohol can be linear or branched, and substituted or un-substituted. Suitable nonionic surfactants include those with the trade name Lutensol® from BASF. The alkyl alkoxylated sulfate may have a broad alkoxy distribution for example Alfonic 1214-9 Ethoxylate or a peaked alkoxy distribution for example Novel 1214-9 both commercially available from Sasol

Cationic Surfactant: Suitable cationic surfactants include alkyl pyridinium compounds, alkyl quaternary ammonium compounds, alkyl quaternary phosphonium compounds, alkyl ternary sulphonium compounds, and mixtures thereof.

Preferred cationic surfactants are quaternary ammonium compounds having the general formula:

(R)(R₁)(R₂)(R₃)N⁺X⁻
wherein, R is a linear or branched, substituted or unsubstituted C₆₋₁₈ alkyl or alkenyl moiety, R₁ and R₂ are independently selected from methyl or ethyl moieties, R₃ is a hydroxyl, hydroxymethyl or a hydroxyethyl moiety, X is an anion which provides charge neutrality, preferred anions include: halides, preferably chloride; sulphate; and sulphonate.

The laundry treatment compositions of the present disclosure may contain up to about 30%, alternatively from about 0.01% to about 20%, more alternatively from about 0.1% to about 20%, by weight of the laundry treatment composition, of a cationic surfactant. Non-limiting examples of useful cationic surfactants include: fatty amines, imidazoline quat materials and quaternary ammonium surfactants, preferably N, N-bis(stearoyl-oxy-ethyl) N,N-dimethyl ammonium chloride, N,N-bis(tallowoyl-oxy-ethyl) N,N-dimethyl ammonium chloride, N,N-bis(stearoyl-oxy-ethyl)N-(2 hydroxyethyl)N-methyl ammonium methylsulfate; N,N-bis(stearoyl-isopropoxy) N,N-dimethyl ammonium methyl sulfate, N,N-bis(tallowoyl-isopropoxy) N,N-dimethyl ammonium methyl sulfate, 1,2 di(stearoyl-oxy) 3 trimethyl ammoniumpropane chloride; dialkylenedimethylammonium salts such as dicanoladimethylammonium chloride, di(hard) tallowdimethylammonium chloride dicanoladimethylammonium methylsulfate; 1-methyl-1-stearoylamidoethyl-2-stearoylimidazolinium methylsulfate; 1-tallowylamidoethyl-2-tallowylimidazoline; N,N″-dialkyldiethylenetriamine; the reaction product of N-(2-hydroxyethyl)-1,2-ethylenediamine or N-(2-hydroxyisopropyl)-1,2-ethylenediamine with glycolic acid, esterified with fatty acid, where the fatty acid is (hydrogenated) tallow fatty acid, palm fatty acid, hydrogenated palm fatty acid, oleic acid, rapeseed fatty acid, hydrogenated rapeseed fatty acid; polyglycerol esters (PGEs), oily sugar derivatives, and wax emulsions and a mixture of the above.

It will be understood that combinations of cationic surfactants disclosed above are suitable for use herein

Amphoteric and Zwitterionic surfactant: Suitable amphoteric or zwitterionic surfactants include amine oxides, and/or betaines. Preferred amine oxides are alkyl dimethyl amine oxide or alkyl amido propyl dimethyl amine oxide, more preferably alkyl dimethyl amine oxide and especially coco dimethyl amino oxide. Amine oxide may have a linear or mid-branched alkyl moiety. Typical linear amine oxides include water-soluble amine oxides containing one R¹ C₈-C₁₈ alkyl moiety and 2 R² and R³ moieties selected from the group consisting of C₁-C₃ alkyl groups and C₁-C₃ hydroxyalkyl groups. Preferably amine oxide is characterized by the formula R¹—N (R²) (R³) O wherein R¹ is a C₈-C₁₈ alkyl and R² and R³ are selected from the group consisting of methyl, ethyl, propyl, isopropyl, 2-hydroxethyl, 2-hydroxypropyl and 3-hydroxypropyl. The linear amine oxide surfactants in particular may include linear C₁₀-C₁₈ alkyl dimethyl amine oxides and linear C₈-C₁₂ alkoxy ethyl dihydroxy ethyl amine oxides.

Other suitable surfactants include betaines, such as alkyl betaines, alkylamidobetaine, amidazoliniumbetaine, sulfobetaine (INCI Sultaines) as well as Phosphobetaines.

### Adjunct Laundry Treatment Ingredients

The laundry treatment compositions of the present disclosure may also contain other laundry treatment ingredients. Suitable ingredients include enzymes, enzyme stabilizers, builders, dispersants, structurants or thickeners, polymers, additional amines, catalytic materials, bleaching agents, bleaching catalysts, bleach activators, polymeric dispersing agents, soil removal/anti-re-deposition agents, polymeric grease cleaning agents, amphiphilic copolymers, fluorescent brightener, fabric hucing agents, chelating agent, encapsulates, perfume, pro-perfumes, malodor reduction materials, conditioning agents, probiotics, organic acids, anti-oxidants, anti-microbial agents and/or preservatives, neutralizers and/or pH adjusting agents, processing aids, rheology modifiers, corrosion and/or anti-tarnishing agents, hygiene Agent, pearlescent agent, pigments, opacifier, solvents, carriers, hydrotrope, suds suppressor and mixtures thereof.

Preferably the laundry treatment composition comprises one or more enzymes. Preferred enzymes provide cleaning performance and/or fabric care benefits. Examples of suitable enzymes include, but are not limited to, hemicellulases, peroxidases, proteases, cellulases, xylanases, lipases, phospholipases, esterases, cutinases, pectinases, mannanases, galactanases, pectate lyases, keratinases, reductases, oxidases, phenoloxidases, lipoxygenases, ligninases, pullulanases, tannases, pentosanases, malanases, β-glucanases, arabinosidases, hyaluronidase, chondroitinase, laccase, and amylases, or mixtures thereof. A typical combination is an enzyme cocktail that may comprise, for example, a protease and lipase in conjunction with amylase. When present in the composition, the aforementioned additional enzymes may be present at levels from about 0.00001% to about 2%, from about 0.0001% to about 1% or even from about 0.001% to about 0.5% enzyme protein by weight of the composition.

The laundry treatment composition may optionally comprise from about 0.001% to about 10%, or even from about 0.005% to about 8%, or even from about 0.01% to about 6%, by weight of the laundry treatment composition, of an enzyme stabilizing system.

The laundry treatment composition may optionally comprise a builder. Built compositions typically comprise at least about 1% builder, based on the total weight of the composition. Liquid compositions may comprise up to about 10% builder, and in some examples up to about 8% builder, of the total weight of the composition. Granular compositions may comprise up to about 30% builder, and in some examples up to about 5% builder, by weight of the composition.

Builders may be selected from aluminosilicates (e.g., zeolite builders, such as zeolite A, zcolite P, and zeolite MAP); silicates; phosphates such as polyphosphates (e.g., sodium tri-polyphosphate), especially sodium salts thereof; carbonates, bicarbonates, sesquicarbonates, and carbonate minerals other than sodium carbonate or sesquicarbonate; organic mono-, di-, tri-, and tetracarboxylates, especially water-soluble nonsurfactant carboxylates in acid, sodium, potassium or alkanolammonium salt form, as well as oligomeric or water-soluble low molecular weight polymer carboxylates including aliphatic and aromatic types; and phytic acid; citric acid, lactic acid, fatty acid and salt thereof.

Suitable builders may include polycarboxylate and salt thereof, for example, homopolymers of acrylic acid, copolymers of acrylic acid and maleic acid, and copolymers of acrylic acid and/or maleic acid, and other suitable ethylenic monomers with various types of additional functionalities.

Also suitable for use as builders herein are synthesized crystalline ion exchange materials or hydrates thereof having chain structure and a composition represented by the following general anhydride form: x(M₂O)·ySiO₂·zM′O wherein M is Na and/or K, M′ is Ca and/or Mg; y/x is 0.5 to 2.0; and z/x is 0.005 to 1.0.

Alternatively, the laundry treatment composition may be substantially free of builder.

Suitable structurant/thickeners may include: di-benzylidene polyol acetal derivative, bacterial cellulose, coated bacterial cellulose, cellulose fibers non-bacterial cellulose derived, non-polymeric crystalline hydroxyl-functional materials, polymeric structuring agents, di-amido-gellants, or any mixtures thereof.

The laundry treatment compositions may include one or more polymers. Typically, the level of polymers is from about 0.01% to about 10.0% by weight of the laundry treatment composition, preferably from about 0.1% to about 5%, and more preferably from about 0.2% to about 3.0% by weight of the laundry treatment composition.

Depending on the structure of the polymer, polymers can provide various benefits for the composition, including but not limit to, hydrophobic and hydrophilic stain removal, surfactant boosting, soil suspension, whiteness maintenance, soil release, malodor control, dye transfer inhibition, enhanced softness, enhanced freshness, etc. Polymers are normally multi-functional, which means one specific given type of polymer may provide more than one types of benefit as mentioned above. For example, a specific soil release polymer may provide soil release benefit as primary benefit, while also providing other benefits such as whiteness maintenance, malodor control, soil suspension, dye transfer inhibition.

Suitable polymers including, but not limited to the following: Graft Polymers Based on Polyalkylene Oxide; Modified Polyamine Dispersing Agent; Polyester Soil Release Polymers; Polymers Based on Polysaccharide; block polymers of ethylene oxide, propylene oxide and butylene oxide.

The laundry treatment composition may comprise dye transfer inhibiting agents.

The laundry treatment composition may comprise one or more other polymeric dispersing agents.

Additional amines may be used in the laundry treatment compositions described herein for added removal of grease and particulates from soiled materials.

It may be preferred for the laundry treatment composition to comprise one or more bleaching agents. Suitable bleaching agents other than bleaching catalysts include photobleaches, bleach activators, hydrogen peroxide, sources of hydrogen peroxide, pre-formed peracids and mixtures thereof.

The laundry treatment composition may comprise a fluorescent brightener. Suitable fluorescent brighetners can be classified into subgroups, including but not limited to: derivatives of stilbene, pyrazoline, coumarin, benzoxazoles, carboxylic acid, methinecyanines, dibenzothiophene-5,5-dioxide, azoles, 5- and 6-membered-ring heterocycles, and other miscellaneous agents.

The laundry treatment composition may comprise a fabric hueing agent (sometimes referred to as shading, bluing or whitening agents).

The laundry treatment composition may comprise chelating agents and/or crystal growth inhibitor. Suitable molecules include copper, iron and/or manganese chelating agents and mixtures thereof. Suitable molecules include hydroxamic acids, aminocarboxylates, aminophosphonates, succinates, salts thereof, and mixtures thereof.

### Delivery Particle

The present disclosure describes a delivery particle comprising a core material and a shell encapsulating the core material. Without wishing to be bound by theory, it was found that when the prior art delivery particles were formulated into certain laundry treatment composition, there resulted an unacceptable level of perfume leakage from the particle. This resulted in lower than desired levels of perfume being delivered to the fabric through the wash operation and so resulting in lower than desired consumer noticeable freshness benefits on fabrics following the wash operation. However, formulation with the delivery particles of the present disclosure provided for consumer acceptable freshness regardless of the laundry treatment form into which they were formulated.

It should be understood that the laundry treatment composition comprises a population of said delivery particles.

The core material comprises a perfume. The shell comprises a polymer.

The shell comprises a polymeric material that is the reaction product of chitosan wherein the reaction product of chitosan is derived from an aqueous phase, and a cross-linking agent.

The cross-linking agent comprises a mixture of two or more di- and/or poly-isocyanates, derived from the oil phase, the di- and/or poly-isocyanates each containing an aromatic moiety. Surprisingly, it has been found that leakage can be controlled as a function of two isocyanates, each comprising at least one aromatic moiety, which when combined with chitosan yield a low leakage delivery particle in different matrices and carriers, to an extent heretofore unachieved with degradable constructs. More particularly the cross-linking agent comprises an isocyanate component, wherein the isocyanate component comprises a mixture of two or more di- and/or poly-isocyanates, derived from an oil phase, the di- and/or poly-isocyanates each comprising an aromatic moiety; and each isocyanate is independently selected from the group consisting of an alpha-aromatic isocyanate and a beta-aromatic isocyanate. The mixture of di- and/or poly-isocyanates may comprise at least one alpha-aromatic isocyanate and at least one beta-aromatic isocyanate.

Enhanced performance in terms of lower leakage and retention of core material in carrier material is surprisingly obtainable wherein the weighted % NCO of the aromatic isocyanate of the isocyanate component is from 15 to 32% or even from 20 to 26%, or even from 20 to 25% by weight, or even from 21 to 25% by weight.

Preferably, at least 21 wt % of the shell comprises chitosan. The isocyanate component may comprise methylenediphenyl isocyanate and xylylene diisocyanate in a weight ratio of from 1:2 to 1:1.75. The isocyanate component may comprise by weight 30 to 40% methylenediphenyl isocyanate and from 60 to 70% xylylene diisocyanate.

The shell comprises a polymeric material that is the reaction product of chitosan derived from an aqueous phase, and a cross-linking agent comprising an isocyanate component comprising a mixture of two or more di- and/or poly-isocyanates, derived from an oil phase, the di- and/or poly-isocyanates each comprising an aromatic moiety. The isocyanates are di-isocyanates, tri-isocyanates or a mixture of di- and tri-isocyanates.

Surprisingly, low leakage can be achieved with careful selection of a mixture of di- and/or poly-isocyanates, comprising alpha or beta-aromatic isocyanates, especially those combinations comprising at least one alpha-aromatic isocyanate and at least one beta-aromatic isocyanate. Surprisingly, low leakage into carrier material is seen when the weighted % NCO of the aromatic isocyanate of the isocyanate component is from 15 to 32% or even from 20 to 26%, or even from 20 to 25% by weight, or even from 21 to 25% by weight. In particular the compositions of the present disclosure comprise an isocyanate component comprising an alpha and/or beta-aromatic isocyanate. The alpha-aromatic isocyanate is selected from the group consisting of:

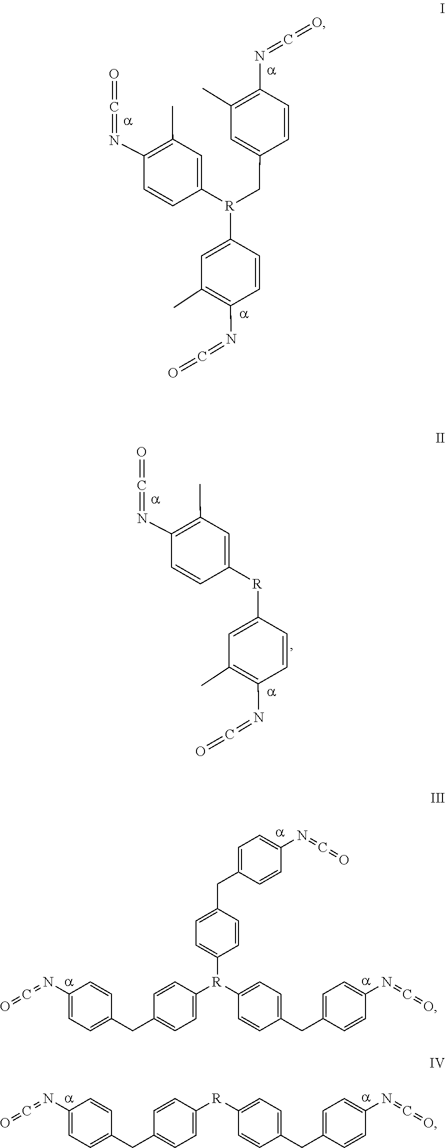

or a mixture thereof.
wherein, R is a polyol having a pendant urethane group, a polyamine having a urea pendant group, a polyacid with an anhydrate group, a poly-isocyanate comprising a biuret, a poly-isocyanate comprising a uretdione, or a polyisocyanate comprising an isocyanurate.

R bonds to the above structures via at least two reactive moieties comprising, for example, an amine group, a hydroxy group, an anhydride, and similar groups that can bond into the listed structure.

R in structures I, II, III and IV and XII and XIII for example comprises moieties with at least two or more functional groups that link into the respective di- or tri-isocyanate. R in structures I, II, III and IV and XII and XIII for example can comprise polyol, or a polyol having one or more pendant urethane groups, or a polyamine, such as a polyamine having one or more urea pendant groups or other linking groups, a polyacid with an anhydrate group, a poly-isocyanate comprising a biuret, a poly-isocyanate comprising a uretdione, or a polyisocyanate comprising an isocyanurate. In structures I, II, III and IV and XII and XIII for example the R moieties include at least two or more functional groups that link into the respective di- or tri-isocyanate.

The aromatic isocyanates of formulas I—XVI are based on derivative variations of generally commercially available isocyanates such as xylylene diisocyanate (XDI), toluene diisocyanate (TDI) and methylene diphenyl diisocyanates (MDI).

The above selected aromatic isocyanates are generally available commercially. For example, Covestro in Leverkusen, Germany is a supplier of polyisocyanates and prepolymers under the Desmodur brand. Polyisocyanates conforming to the structures I-XVI disclosed herein are available under the Desmodur E brand of isocyanates and prepolymers, and/or can also be derived synthetically. Optionally aromatic isocyanates are also commercially available from sources such as Mitsui Chemicals, Inc., Tokyo, Japan such as the Takenate brand of isocyanates, e.g., Takenate D-110N adducts based on xylylene diisocyanate.

Specific examples of alpha-aromatic isocyanates useful in the present disclosure can be selected from the group consisting of:

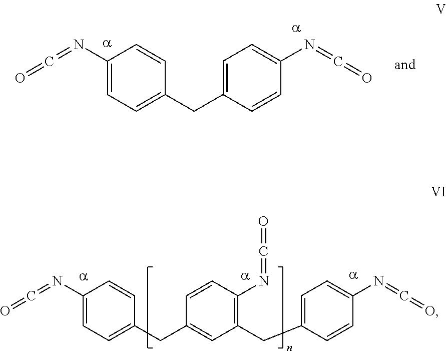

wherein, n is an integer from 1 to 24, preferably from 1 to 18, or even from 1 to 12, or even from 1 to 8.

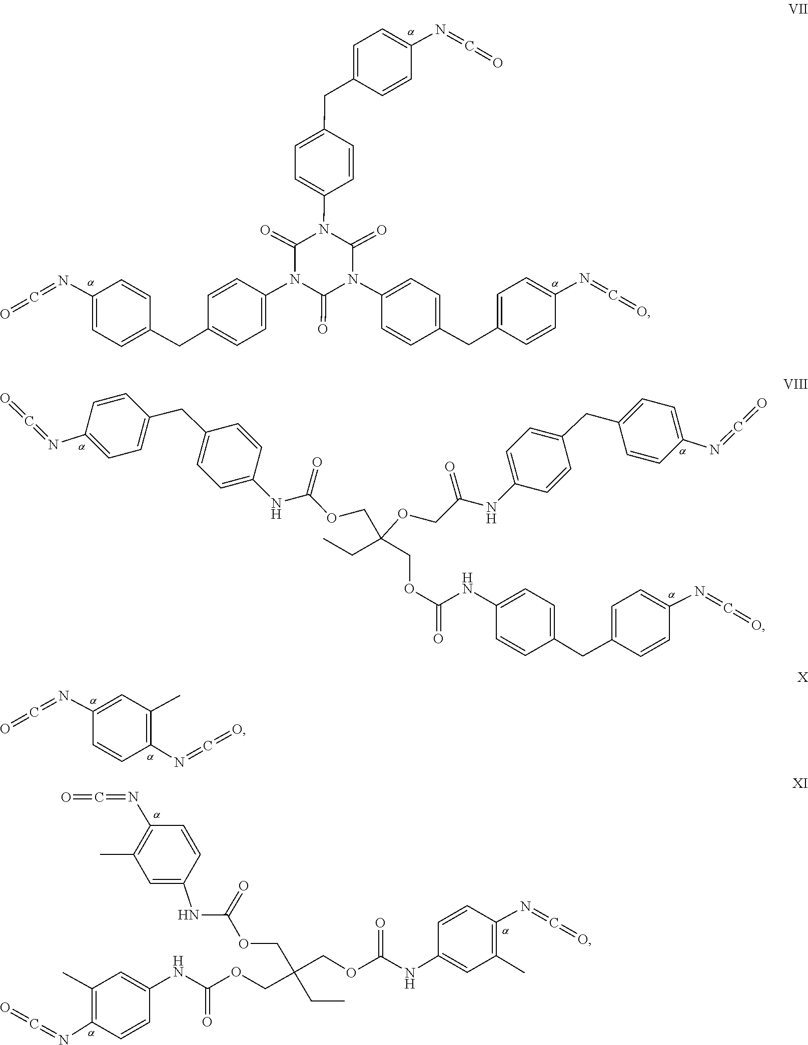

or a mixture thereof.

The beta-aromatic isocyanate useful in the present disclosure can be selected from the group consisting of:

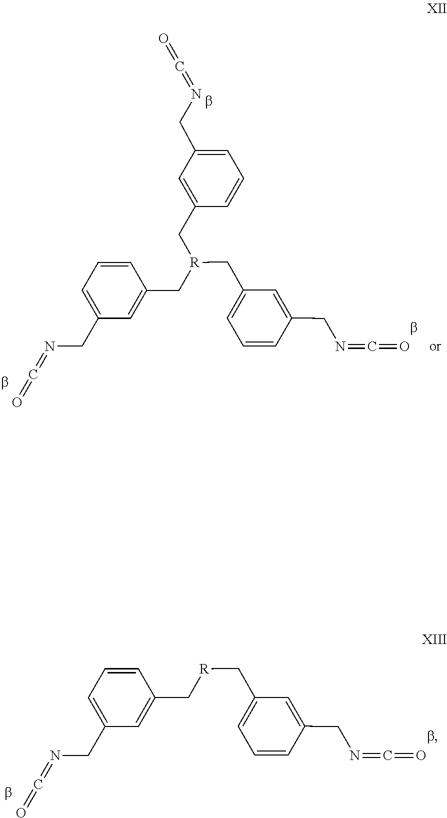

or a mixture thereof,
wherein, R is a polyol having a pendant urethane group, a polyamine having a urea pendant group, a polyacid with an anhydrate group, a poly-isocyanate comprising a biuret, a poly-isocyanate comprising a uretdione, a polyisocyanate comprising an isocyanurate.

The alpha-aromatic isocyanate can also be selected from the group consisting of toluene diisocyanate, methylene diphenyl diisocyanate, polymeric methylene diphenyl diisocyanate, naphthalene diisocyanate, phenylene diisocyanate, isomers thereof, adducts thereof, and combinations thereof, and preferably selected from methylene diphenyl diisocyanate, polymeric methylene diphenyl diisocyanate, isomers thereof, adducts thereof, and combinations thereof.

Specific examples of beta aromatic isocyanates useful in the present disclosure can be selected from the group consisting of:

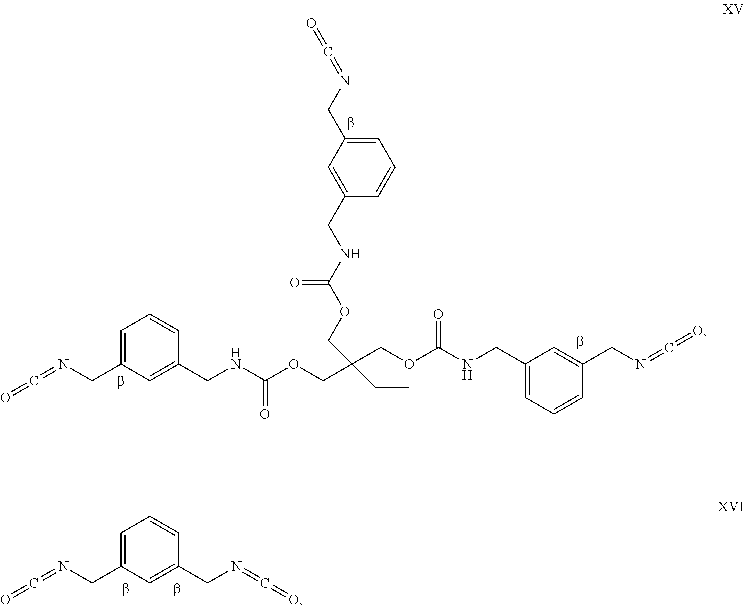 [SMILES: CCC(COC(=O)NCc1cccc(CN=C=O)c1)(COC(=O)NCc1cccc(CN=C=O)c1)COC(=O)NCc1cccc(CN=C=O)c1 ; O=C=NCc1cccc(CN=C=O)c1]

or mixtures thereof.

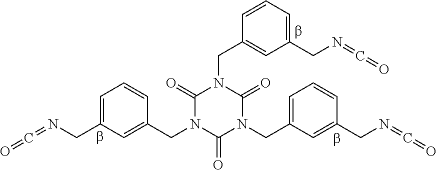 [SMILES: O=C=NCc1cccc(Cn2c(=O)n(Cc3cccc(CN=C=O)c3)c(=O)n(Cc3cccc(CN=C=O)c3)c2=O)c1]

The beta-aromatic isocyanate can also be selected from the group consisting of xylylene diisocyanate, trimethylolpropane adducts of xylylene diisocyanate, tetramethylxylidene diisocyanate, isomers thereof, adducts thereof, and combinations thereof.

The mass percent of the alpha-aromatic isocyanate in the isocyanate component may be from 1% to 99% by weight, preferably from 5 to 90% by weight, most preferably from 30 to 60% by weight.

The mass percent of the beta-aromatic isocyanate in the isocyanate component may be from 1% to 99% by weight, preferably from 5% to 10% by weight, most preferably from 70% to 40% by weight.

The isocyanate component can comprise at least two di- and/or poly-isocyanates selected from methylene diphenyl diisocyanate and xylylene diisocyanate. The xylylene diisocyanate may comprise a trimethylol propane-adduct of xylylene diisocyanate. the methylene diphenyl diisocyanate can be selected from 2,2′-methylenediphenyl diisocyanate and 4,4′-methylenediphenyl diisocyanate. Preferably the isocyanate components are in a weight ratio of from 1:2 to 1:1.75. Desirably the isocyanate component comprises by weight 30 to 40% of a methylene diphenyl diisocyanate and from 60 to 70% of a xylylene diisocyanate. Usefully, the isocyanate component comprises by weight about 34% methylene diphenyl diisocyanate and about 66% xylylene diisocyanate. Chitosan in combination with the isocyanate component within this isocyanate range or ratio surprisingly is able to efficiently deliver benefit agent at desired touchpoints. Leakage into matrice components and/or carriers is surprisingly reduced as a function of the combination with two isocyanates with the chitosan. The mixture of isocyanates having an aromatic moiety for example can comprise for example trimers of xylylene diisocyanate (XDI) or oligomers or pre-polymers of methylene diphenyl diisocyanate (MDI).

Optionally, prior to shell formation, the chitosan used to make the particle shells can be treated such with acid, or even a mixture of acids or with a redox initiator preferably persulfate. The redox initiator is selected from any of persulfate or a peroxide. Preferably, the redox initiator is selected from the group consisting of ammonium persulfate, sodium persulfate, potassium persulfate, cesium persulfate, benzoyl peroxide, hydrogen peroxide, and mixtures thereof.

Typically, when chitosan is dissolved in water, for example during the process of making delivery particles, the resulting mixture tends to be quite viscous. This can result in flowability and processing challenges, and/or inhibit the adequate formation of delivery particle shells. Acid treatment can result in a decrease of the mixture's viscosity and an improved shell structure. Additionally, it is believed that acid treating the chitosan can beneficially affect the molecular weight of the chitosan, thereby leading to improved shell formation and/or delivery performance.

The delivery particles have shells made, at least in part, from chitosan-based materials. In particular, the delivery particles include a shell comprising a reaction product of chitosan and the isocyanate component.

Without wishing to be bound by theory, it is believed that careful selection of the chitosan and isocyanate combination within the weight ratios of the composition of the present disclosure is advantageous in surprisingly achieving a long shelf-life composition containing delivery particles. For example, selection of an isocyanate component according to the present disclosure result in delivery particles that perform better at certain touchpoints. It is believed that the combination of isocyanates of the present disclosure yields a higher density delivery particle. It is believed that the surprising effect of reduced leakage is attributable to not only density of the polymeric material but also related to the presence of aromatic moieties in combination with the reactive sites of the isocyanate component.

Without wishing to be bound by theory, it is believed that careful selection of the chitosan's molecular weight can be advantageous. For example, selection of a chitosan having a molecular weight above a certain threshold can result in delivery particles that perform better at certain touchpoints compared to particles made from chitosan of a lower molecular weight. Surprisingly treatment with acid can yield a chitosan at a 3.5% concentration, typically having a starting viscosity or approximately 4000 cP, displaying a viscosity reduction of 60% or even exceeding 60%, to a viscosity of 1500 cP, or even 1000 cP at the same concentration as compared to an untreated chitosan.

The chitosan is characterized by preferably a weight average molecular weight of from about 100 to about 80,000 kDa, or even from 100 kDa to about 600 kDa. Preferably, the chitosan is characterized by a weight average molecular weight (Mw) of from about 100 kDa to about 500 kDa, preferably from about 100 kDa to about 400 kDa, more preferably from about 100 kDa to about 300 kDa, even more preferably from about 100 kDa to about 200 kDa. The method used to determine the chitosan's molecular weight and related parameters is provided in the Test Methods section below and uses gel permeation chromatograph with multi-angle light scatter and refractive index detection (GPC-MALS/RI) techniques. Selecting chitosan having the preferred weight average molecular weight can result in delivery particles having suitable shell formation and/or desirable processibility. For clarity the chitosan weight average molecular weight is measured prior to treatment, such as with acid and/or redox initiator as herein described.

The ratio of the isocyanate component cross-linking agent to chitosan, based on weight, is preferably 79:21 to 10:90, or even 2:1 to 1:10, or even 1:1 to 1:7.

The cross-linking agent of the composition optionally can comprise additional polyisocyanate to the mixture of two or more di- or poly-isocyanates. The additional cross-linking agent can be an aliphatic or aromatic monomer, oligomer or prepolymer, usefully of two or more isocyanate functional groups Additional crosslinking agents of the isocyanate type, for example, can be selected from aromatic toluene diisocyanate and its derivatives used in wall formation for delivery particles, or aliphatic monomer, oligomer or prepolymer, for example, hexamethylene diisocyanate and dimers or trimers thereof, or 3,3,5-trimethyl-5-isocyanatomethyl-1-isocyanato cyclohexane tetramethylene diisocyanate, polyisocyanurate of toluene diisocyanate, a trimethylol propane adduct of toluene diisocyanate, toluene diisocyanate, tetramethylxylidene diisocyanate, naphthalene-1,5-diisocyanate, phenylene diisocyanate, 1,3-diisocyanato-2-methylbenzene, hydrogenated MDI, bis(4-isocyanatocyclohexyl) methane, dicyclohexylmethane-4,4′-diisocyanate, and oligomers and prepolymers thereof. The additional isocyanates useful in the present disclosure comprise isocyanate monomers, oligomers or prepolymers, or dimers or trimers thereof, having at least two isocyanate groups. Optimal cross-linking can be achieved with isocyanates having at least three functional groups. This listing is illustrative and not intended to be limiting.

Additional crosslinking agents of the isocyanate type can be formed from adducts of polyisocyanates. An adduct is the product of a molecule with itself and/or with another molecule. In the case of adducts of polyisocyanates with themselves, the isocyanate moieties of the polyisocyanate molecule can react with each other, forming a larger polyisocyanate product containing biuret, uretdione, and/or isocyanurate moieties. In the case of polyol adducts of polyisocyanates, the isocyanate moieties of the polyisocyanate molecule can react with the hydroxyl moieties of a polyol, forming a larger polyisocyanate product containing urethane moieties. In the case of polyamine adducts of polyisocyanates, the isocyanate moieties of the polyisocyanate molecule can react with the amine moieties of a polyamine, forming a larger polyisocyanate product containing urea moieties. In the case of polyacid adducts of polyisocyanates, the isocyanate moieties of the polyisocyanate molecule can react with the carboxylic moieties of a polyacid, forming a larger polyisocyanate product containing anhydride moieties. Where a polyisocyanate is a molecule containing 2 or more isocyanate moieties.

Without wishing to be bound by theory, it is believed that the mixed isocyanate system according to the present disclosure makes the shell less hygroscopic due to the choice of the two specific isocyanates. The shell comprising one of the isocyanates only does not provide the benefit of reduced leakage.

To create the delivery particle of the present disclosure a water phase is prepared, comprising a water solution or dispersion of an amine-containing natural material having free amino moieties. The amine containing natural material is a bio-based material. Such materials for example include chitosan. The amine-containing natural material is dispersed in water. In the case of chitosan, the material, in embodiments, can even be hydrolyzed thereby protonating at least a portion of the amine groups and facilitating dissolving in water. Hydrolysis is carried out with heating for a period at an acidic pH such as about 3 to about 6.5, or even about 5 or 5.5.

The oil phase is prepared by dissolving the isocyanate component in oil at 25° C. Diluents, for example isopropyl myristate, may be used to adjust the hydrophilicity of the oil phase. The oil phase is then added into the water phase and milled at high speed to obtain a targeted size. The emulsion is then cured in one or more heating steps, such as heating to 40° C. in 30 minutes and holding at 40° C. for 60 minutes. Times and temperatures are approximate. The temperature and time are selected to be sufficient to form and cure a shell at the interface of the droplets of the oil phase with the water continuous phase. For example, the emulsion is heated to 85° C. in 60 minutes and then held at 85° C. for 360 minutes to cure the delivery particles. The slurry is then cooled to room temperature.

Volume weighted median particle size of delivery particles according to the present disclosure can range from 5 microns to 150 microns, or even from 10 to 50 microns, preferably 15 to 50 microns.

The cross-linking agent of the present disclosure is a mixture or bi- or poly-functional isocyanates. When referring to useful cross-linking agents reference to polyisocyanate should be understood for purposes hereof as inclusive of isocyanate monomer, isocyanate oligomer, isocyanate prepolymer, or dimer or trimer of an aliphatic or aromatic isocyanate. All such monomers, prepolymers, oligomers, or dimers or trimers of aliphatic or aromatic isocyanates are intended by the term “polyisocyanate” as used herein.

The delivery particle shell could also be reinforced using additional co-crosslinkers such as multifunctional amines and/or polyamines such as diethylene triamine (DETA), polyethylene imine, and polyvinyl amine.

The shell may also be reinforced using additional co-crosslinkers such as multifunctional amines and/or polyamines, such as diethylene triamine (DETA), polyethylene imine, polyvinyl amine, or mixtures thereof. Acrylates may also be used as additional co-crosslinkers, for example to reinforce the shell.

The polymeric material may be formed in a reaction, where the weight ratio of the chitosan present in the reaction to the cross-linker present in the reaction is from about 1:10 to about 1:0.1. It is believed that selecting desirable ratios of the biopolymer to the cross-linking agent can provide desired ductility benefits, as well as improved biodegradability. It may be preferred that at least 21 wt % of the shell is comprised of moieties derived from chitosan, preferably from acid-treated chitosan. Chitosan as a percentage by weight of the shell may be from about 21% up to about 95% of the shell. The ratio of chitosan in the water phase as compared to the isocyanate in the oil phase may be, based on weight, from 21:79 to 90:10, or even from 1:2 to 10:1, or even from 1:1 to 7:1. The shell may comprise chitosan at a level of 21 wt % or even greater, preferably from about 21 wt % to about 90 wt %, or even from 21 wt % to 85 wt %, or even 21 wt % to 75 wt %, or 21 wt % to 55 wt % of the total shell being chitosan. The chitosan of this paragraph may optionally be acid-treated chitosan or treated with a redox initiator such as persulfate or both.

Chitosan may be added into water in a jacketed reactor and optionally pre-treated with one or both of redox initiator or at a pH from 3 to 6.5, adjusted using an acid (such as one or more of HCl, formic acid or acetic acid). The optional pretreatment step can be accomplished by heating to elevated temperature, such as 85° C. in 60 minutes, and then holding at this temperature from 1 minute to 1440 minutes or longer. The water phase then may be cooled to 25° C. Optionally, a deacetylating step may be added to further facilitate or enhance depolymerization or deacetylation of the chitosan such as by enzymes. An oil phase is prepared by dissolving a mixture of isocyanates, comprising an aromatic moiety, in oil at 25° C. Diluents, for example isopropyl myristate, may be used to adjust the hydrophobicity of the oil phase. The oil phase may then be added into the water phase and milled at high speed to obtain a targeted size. The emulsion may then be cured in one or more heating steps, such as heating to 40° C. in 30 minutes and holding at 40° C. for 60 minutes. Times and temperatures are approximate. The temperature and time are selected to be sufficient to form and cure a shell at the interface of the droplets of the oil phase with the water continuous phase. For example, the emulsion may be heated to 85° C. in 60 minutes and then held at 85° C. for 360 minutes to cure the particles. The slurry may then be cooled to room temperature.

The shell may degrade at least 50% after 20 days (or less) when tested according to test method OECD 301B. The shell may degrade at least 60% of its mass after 60 days (or less) when tested according to test method OECD 301B. The shell may preferably degrade at least 60% of its mass after 60 days (or less) when tested according to test method OECD 301B. The shell may degrade from 30-100%, preferably 40-100%, 50-100%, 60-100%, or 60-95%, in 60 days, preferably 50 days, more preferably 40 days, more preferably 28 days, more preferably 14 days.

The delivery particles may consist of one or more distinct populations. The composition may have at least two different populations of delivery particles that vary in the exact make-up of the perfume oil and in the median particle size and/or partitioning modifier to perfume oil (PM:PO) weight ratio. The laundry treatment composition may include more than two distinct populations that vary in the exact make up the perfume oil and in their fracture strengths. The populations of delivery particles can vary with respect to the weight ratio of the partitioning modifier to the perfume oil(s). The laundry treatment composition can include a first population of delivery particles having a first ratio that is a weight ratio of from 2:3 to 3:2 of the partitioning modifier to a first perfume oil and a second population of delivery particles having a second ratio that is a weight ratio of less than 2:3 but greater than 0 of the partitioning modifier to a second perfume oil.

Each distinct population of delivery particles may be prepared in a distinct slurry. For example, the first population of delivery particles can be contained in a first slurry and the second population of delivery particles contained in a second slurry. It is to be appreciated that the number of distinct slurries for combination is without limit and a choice of the formulator such that 3, 10, or 15 distinct slurries may be combined. The first and second populations of delivery particles may vary in the exact makeup of the benefit agent, such as the perfume oil, and in the median particle size and/or PM:PO weight ratio.

The laundry treatment composition can be prepared by combining the first and second slurries with at least one adjunct ingredient and optionally packaged in a container. The first and second populations of delivery particles can be prepared in distinct slurries and then spray dried to form a particulate. The distinct slurries may be combined before spray drying, or spray dried individually and then combined together when in particulate powder form. Once in powder form, the first and second populations of delivery particles may be combined with an adjunct ingredient to form the composition useful as a feedstock for manufacture of consumer, industrial, medical or other goods. In some examples, at least one population of delivery particles is spray dried and combined with a slurry of a second population of delivery particles. In some examples, at least one population of delivery particles is dried, prepared by spray drying, fluid bed drying, tray drying, or other such drying processes that are available. Preferably, the volume weighted median particle size of delivery particles according to the present disclosure can range from 5 microns to 150 microns, or even from 10 to 50 microns, preferably 15 to 50 microns.

The slurry or dry particulates can include one or more adjunct materials such as processing aids selected from the group consisting of a carrier, an aggregate inhibiting material, a deposition aid, a particle suspending polymer, and mixtures thereof. Non-limiting examples of aggregate inhibiting materials include salts that can have a charge-shielding effect around the particle, such as magnesium chloride, calcium chloride, magnesium bromide, magnesium sulfate, and mixtures thereof. Non-limiting examples of particle suspending polymers include polymers such as xanthan gum, carrageenan gum, guar gum, shellac, alginates, chitosan; cellulosic materials such as carboxymethyl cellulose, hydroxypropyl methyl cellulose, cationically charged cellulosic materials; polyacrylic acid; polyvinyl alcohol; hydrogenated castor oil; ethylene glycol distearate; and mixtures thereof.

The slurry can include one or more processing aids, selected from the group consisting of water, aggregate inhibiting materials such as divalent salts; particle suspending polymers such as xanthan gum, guar gum, carboxy methyl cellulose.

The slurry can include one or more carriers selected from the group consisting of polar solvents, including but not limited to, water, ethylene glycol, propylene glycol, polyethylene glycol, glycerol; nonpolar solvents, including but not limited to, mineral oil, perfume raw materials, silicone oils, hydrocarbon paraffin oils, and mixtures thereof.

The slurry may include a deposition aid that may comprise a polymer selected from the group comprising: polysaccharides, in one aspect, cationically modified starch and/or cationically modified guar; polysiloxanes; poly diallyl dimethyl ammonium halides; copolymers of poly diallyl dimethyl ammonium chloride and polyvinyl pyrrolidone; a composition comprising polyethylene glycol and polyvinyl pyrrolidone; acrylamides; imidazoles; imidazolinium halides; polyvinyl amine; copolymers of poly vinyl amine and N-vinyl formamide; polyvinyl formamide, polyvinyl alcohol; polyvinyl alcohol crosslinked with boric acid; polyacrylic acid; polyglycerol ether silicone cross-polymers; polyacrylic acids, polyacrylates, copolymers of polyvinylamine and polvyinylalcohol oligomers of amines, in one aspect a diethylenetriamine, ethylene diamine, bis(3-aminopropyl) piperazine, N,N-Bis-(3-aminopropyl)methylamine, tris(2-aminoethyl)amine and mixtures thereof; polyethyleneimine, a derivatized polyethyleneimine, in one aspect an ethoxylated polyethyleneimine; a polymeric compound comprising, at least two moieties selected from the moieties consisting of a carboxylic acid moiety, an amine moiety, a hydroxyl moiety, and a nitrile moiety on a backbone of polybutadiene, polyisoprene, polybutadiene/styrene, polybutadiene/acrylonitrile, carboxyl-terminated polybutadiene/acrylonitrile or combinations thereof; pre-formed coacervates of anionic surfactants combined with cationic polymers; polyamines and mixtures thereof.

At least one population of delivery particles can be contained in an agglomerate and then combined with a distinct population of delivery particles and at least one adjunct material. Said agglomerate may comprise materials selected from the group consisting of silicas, citric acid, sodium carbonate, sodium sulfate, sodium chloride, and binders such as sodium silicates, modified celluloses, polyethylene glycols, polyacrylates, polyacrylic acids, zeolites and mixtures thereof.

Suitable equipment for use in the processes disclosed herein may include continuous stirred tank reactors, homogenizers, turbine agitators, recirculating pumps, paddle mixers, plough shear mixers, ribbon blenders, vertical axis granulators and drum mixers, both in batch and, where available, in continuous process configurations, spray dryers, and extruders. Such equipment can be obtained from Lodige GmbH (Paderborn, Germany), Littleford Day, Inc. (Florence, Ky., U.S.A.), Forberg AS (Larvik, Norway), Glatt Ingenieurtechnik GmbH (Weimar, Germany), Niro (Soeborg, Denmark), Hosokawa Bepex Corp. (Minneapolis, Minn., U.S.A.), Arde Barinco (New Jersey, U.S.A.).

### Perfume

The core may comprise from about 5% to about 100%, by weight of the core, of a perfume. The core may comprise from about 45% to about 95%, preferably from about 50% to about 80%, more preferably from about 50% to about 70%, by weight of the core, of the perfume.

The perfume may comprise an aldehyde-comprising benefit agent, a ketone-comprising benefit agent, or a combination thereof. Such aldehyde- or ketone-containing perfume raw materials, are known to provide preferred benefits, such as freshness benefits. The perfume may comprise at least about 20%, preferably at least about 25%, more preferably at least about 40%, even more preferably at least about 50%, by weight of the perfume, of aldehyde-containing benefit agents, ketone-containing benefit agents, or combinations thereof.

The term “perfume raw material” (or “PRM”) as used herein refers to compounds having a molecular weight of at least about 100 g/mol and which are useful in imparting an odor, fragrance, essence or scent, either alone or with other perfume raw materials. Typical PRMs comprise inter alia alcohols, ketones, aldehydes, esters, ethers, nitrites and alkenes, such as terpene. The PRMs may be characterized by their boiling points (B.P.) measured at the normal pressure (760 mm Hg), and their octanol/water partitioning coefficient (P), which may be described in terms of logP, determined according to the test method below. Based on these characteristics, the PRMs may be categorized as Quadrant I, Quadrant II, Quadrant III, or Quadrant IV perfumes. Perfume raw materials having a boiling point B.P. lower than about 250° C. and a logP lower than about 3 are known as Quadrant I perfume raw materials. Quadrant I perfume raw materials are preferably limited to less than 30% of the fragrance material.

The perfume may comprise perfume raw materials that have a logP of from about 2.5 to about 4. It is understood that other perfume raw materials may also be present in the fragrance.

### Test Methods

It is understood that the test methods disclosed in the Test Methods section of the present application should be used to determine the respective values of the parameters of Applicant's claimed subject matter as claimed and described herein.

### Determination of a Polymer's Molecular Weight and Related Parameters

The following method describing gel permeation chromatograph with multi-angle light scatter and refractive index detection (GPC-MALS/RI) is used to find molecular weight distribution measurements and related values of the polymers described herein. Gel Permeation Chromatography (GPC) with Multi-Angle Light Scattering (MALS) and Refractive Index (RI) Detection (GPC-MALS/RI) permits the measurement of absolute molecular weight of a polymer without the need for column calibration methods or standards. The GPC system allows molecules to be separated as a function of their molecular size. MALS and RI allow information to be obtained on the number average (Mn) and weight average (Mw) molecular weight.

The Mw distribution of water-soluble polymers like chitosan is typically measured by using a Liquid Chromatography system (e.g., Agilent 1260 Infinity pump system with OpenLab Chemstation software, Agilent Technology, Santa Clara, CA, USA) and a column set (e.g., 2 Tosoh TSKgel G6000WP 7.8×300 mm 13 μm pore size, guard column A0022 6 mm×40 mm PW x1-cp, King of Prussia, PA) which is operated at 40° C. . . . The mobile phase is 0.1M sodium nitrate in water containing 0.02% sodium azide and 0.2% acetic acid. The mobile phase solvent is pumped at a flow rate of 1 mL/min, isocratically. A multiangle light scattering (18-Angle MALS) detector DAWN® and a differential refractive index (RI) detector (Wyatt Technology of Santa Barbara, Calif., USA) controlled by Wyatt Astra® software v8.0 are used.

A sample is typically prepared by dissolving chitosan materials in the mobile phase at ˜1 mg per ml and by mixing the solution for overnight hydration at room temperature. The sample is filtered through a 0.8 μm Versapor membrane filter (PALL, Life Sciences, NY, USA) into the LC autosampler vial using a 3-ml syringe before the GPC analysis.

A dn/dc value (differential change of refractive index with concentration, 0.15) is used for the number average molecular weight (Mn), weight average molecular weight (Mw), Z-average molecular weight (Mz), molecular weight of the peak maxima (Mp), and polydispersity (Mw/Mn) determination by the Astra detector software.

### Viscosity

Viscosity of liquid finished product is measured using an AR 550 rheometer/viscometer from
TA instruments (New Castle, DE, USA), using parallel steel plates of 40 mm diameter and a gap size of 500 μm. The high shear viscosity at 20 s⁻¹ and low shear viscosity at 0.05 s⁻¹ is obtained from a logarithmic shear rate sweep from 0.01 s⁻¹ to 25 s⁻¹ in 3 minutes time at 21° C. . . .
   Test Method for Determining logP.

The value of the log of the Octanol/Water Partition Coefficient (logP) is computed for each material (e.g., each PRM in the perfume mixture) being tested. The logP of an individual material (e.g., a PRM) is calculated using the Consensus logP Computational Model, version 14.02 (Linux) available from Advanced Chemistry Development Inc. (ACD/Labs) (Toronto, Canada) to provide the unitless logP value. The ACD/Labs' Consensus logP Computational Model is part of the ACD/Labs model suite.

### Volume-Weighted Particle Size and Size Distribution

The volume-weighted particle size distribution is determined via single-particle optical sensing (SPOS), also called optical particle counting (OPC), using the AccuSizer 780 AD instrument and the accompanying software CW788 version 1.82 (Particle Sizing Systems, Santa Barbara, California, U.S.A.), or equivalent. The instrument is configured with the following conditions and selections: Flow Rate=1 ml/sec; Lower Size Threshold=0.50 μm; Sensor Model Number=Sensor Model Number=LE400-05 or equivalent; Autodilution=On; Collection time=60 sec; Number channels=512; Vessel fluid volume=50 ml; Max coincidence=9200. The measurement is initiated by putting the sensor into a cold state by flushing with water until background counts are less than 100. A sample of delivery particles in suspension is introduced, and its density of delivery particles adjusted with DI water as necessary via autodilution to result in delivery particle counts of at least 9200 per ml. During a time period of 60 seconds the suspension is analyzed. The resulting volume-weighted PSD data are plotted and recorded, and the values of the desired volume-weighted particle size (e.g., the median/50th percentile, 5th percentile, and/or 90th percentile) are determined.

### Procedure for Determination of % Degradation

degradation is determined by the “OECD Guideline for Testing of Chemicals” 301B CO₂ Evolution (Modified Sturm Test), adopted 17 Jul. 1992. For ease of reference, this test method is referred to herein as test method OECD 301B.

### Spray-Drying Procedure

This method transforms the delivery particle slurry into a powder by removing the water in the slurry via spray drying. The slurry is diluted to 19-21% solids via RO water. The slurry is then spraydried on a Buchi Mini Spray Dryer B-290 with an inlet temperature of 180 C, aspirator of 90%, and pump of 20-65% to target an outlet temperature of 90 C. The resulting spray-dried delivery particle powder is collected from the collection vessel.

### Free Oil Procedure

This method determines the “Free Oil” of the delivery particle powder. 200-250 mg of powder is placed and measured into a 20 mL scintillation vial. 10 mL hexane is added. The vial is capped and vortexed at 3000 RPM for 5 seconds, and then sit at 2 minutes to settle solids. At least 2 mL of the solvent solution is extracted via a syringe, and then filtered through a 0.45 μm syringe filter into a Gas Chromatography (GC) injection vial. The solution is injected into the GC instrument and the concentration of perfume in the solvent is determined, via reference to a calibration curve created by serial dilutions of perfume dissolved in hexane. The “free oil” is then calculated as the mass fraction of perfume in the 10 mL of hexane relative to the mass of the powder. For a sample of powder, two duplicates of this procedure are done, and the results are averaged. The standard deviation is calculated from the two points and provided with the average value.

### Leakage Procedure

The amount of perfume leakage from the delivery particles is determined according to the following method:
i) Obtain two 1 g samples of delivery particles.
ii) Add 1 g of delivery particles to 99 g of the laundry treatment composition in which the particles will be employed and label the mixture as Sample 1. Immediately use the second 1 g sample of delivery particles in Step d below, in its neat form without contacting the laundry treatment composition, and label it as Sample 2.
iii) Age the delivery particle-containing product matrix (Sample 1) for 1 week at 35° C. in a sealed glass jar.
iv) Using filtration, recover the particles from both samples. The particles in Sample 1 are recovered after the aging step. The particles in Sample 2 are recovered at the same time that the aging step began for sample 1.
v) Treat the recovered particles with a solvent to extract the perfume materials from the particles.
vi) Analyze the solvent containing the extracted perfume from each sample, via chromatography.
vii) Integrate the resultant pefume peak areas under the curve and sum these areas to determine the total quantity of benefit agent extracted from each sample.
viii) Determine the percentage of perfume leakage by calculating the difference in the values obtained for the total quantity of perfume extracted from Sample 2 (S2) minus Sample 1 (S1), expressed as a percentage of the total quantity of perfume extracted from Sample 2 (s₂), as represented in the equation below:

$$\% Leakage = ( \frac{S 2 - S 1}{S 2} ) \times 100$$

Two duplicates of this procedure are done, and the results are averaged. The standard deviation is calculated from the two points and provided with the average value.

### Method to Determine Headspace Concentration Above Treated Dry Fabrics.

Miele washing machines were used to treat the fabrics. For each treatment, the washing machine was loaded with 3 kg fabric, comprising 1100 g knitted cotton fabric, 1100 g polyester-cotton fabrics (50/50). Additionally, 18 terry towel cotton tracers are also added, which weight together about 780 g.

Prior to the test treatment, the load is preconditioned twice, each time using the 95° C. short cotton cycle with 79 g of unperfumed IEC A Base detergent (ex WFK Testgewebe GmbH), followed by two additional 95° C. washes without detergent.

For the test treatment, the load is washed using a 30° C. short cotton cycle, 1400 rpm spin speed with 20.6 g of Unit Dose Article which was previously aged for 4 weeks at 35° C. in a sealed glass jar.

At the end of the treatment cycle, the terry towel tracers are removed from the washing machine. Wet terry towel tracers are either analyzed by fast headspace GC/MS (gas chromatography mass spectrometry) approach, as described below and line-dried overnight. The next day, the dry terry towel tracers are analyzed by fast headspace GC/MS (gas chromatography mass spectrometry) approach, as described below. All treatments washed at the same day for comparative purpose and analyzed on the same day are reported as “one wash test.”

The fabric tracers from the abovementioned Fabric Treatment method are analyzed via headspace analysis at least three specific touchpoints:
WFO (Wet Fabric Odor, or WET): Wet fabrics are analyzed after the fabric treatment method is finished.
DFO (Dry Fabric Odor, or DRY): Dried Fabrics are analyzed after the fabrics have been line-dried in a closed room for approximately twenty-four hours.
RFO (Rub Fabric Odor): Dried Fabrics are placed into the 25 ml headspace vial and are compressed with a weighted rod (total weight 3.62 kg, 4.62 bar) for 10 seconds, afterwards the vial is left for 10 seconds without compression after which the vial is closed.

The headspace above the cotton terry tracers is analyzed using SPME headspace GC/MS (gas chromatography mass spectrometry) approach. 4 cm×4 cm aliquots of cotton tracers are transferred to 25 ml headspace vials. The fabric samples are equilibrated for 10 minutes at 65° C. The headspace above the fabrics is sampled via SPME (50/30 μm DVB/Carboxen/PDMS) for 5 minutes. The SPME fiber is subsequently on-line thermally desorbed into the GC. The analytes are analyzed by GC/MS in full scan mode. The total perfume HS response and perfume headspace composition above the tested legs can be determined.

### % NCO

The % NCO of Isocyanate compounds is calculated as below Equation:

$$\% NCO = \frac{Number of NCO groups \cdot MW NCO group}{MW Isocyanate compound}$$

Where Number of NCO groups is the count of isocyanate groups present in the compound, MW NCO group is the molecular weight of a single NCO group, MW Isocyanate compound is the molecular weight of the entire isocyanate compound, excluding any solvent or other substances that may be mixed with the isocyanate.

When isocyanate is used as a mixture of multiple isocyanates, the % NCO is reported as the weighted sum of mass percentages for each individual isocyanate within the mixture.

All temperatures herein are in degrees Celsius (C) unless otherwise indicated. Unless otherwise specified, all measurements herein are conducted at 20° C. and under the atmospheric pressure.

### Spray-Drying Procedure

This method transforms the microcapsule slurry into a powder by removing the water in the slurry via spray drying. The slurry is diluted to 19-21% solids via RO water. The slurry is then spraydried on a Buchi Mini Spray Dryer B-290 with an inlet temperature of 180 C, aspirator of 90%, and pump of 20-65% to target an outlet temperature of 90 C. The resulting spray-dried microcapsule powder is collected from the collection vessel.

### Beads Making Procedure

PEG 8000 is melted in the oven at 80 C. After the PEG 8000 becomes entirely molten, it is removed from the oven and allowed to cool to 60 C. The delivery particle slurry is added to the molten PEG 8000 blended with a spatula. The blend is put back into the oven for 3 hours to simulate the production process. Afterwards, it is removed from the oven and poured onto a mold to form the solid Beads. The blend is left to cool and is demolded to obtain the final Beads product containing the delivery particles.

Determining Amount of Perfume Loss after Making of Beads

1.25 g of the Beads containing (encapsulated) perfume is dissolved in 100 g water. From this solution a 1.00 g sample is taken and pipetted into a 20 ml headspace vial. The headspace above the solution is analyzed using SPME headspace GC/MS (gas chromatography mass spectrometry) approach. The sample is incubated at 30 C for 10 min. The headspace above the solution is sampled via SPME (50/30 μm DVB/Carboxen/PDMS) for 1 min. The SPME fiber is subsequently on-line thermally desorbed into the GC for 5 min. The analytes are analyzed by GC/MS in full scan mode with a Split ratio of 1:10. The total perfume HS response and perfume headspace composition above the tested legs can be determined.

The total perfume HS response obtained via the method described above is measured for a Bead sample containing a certain type and amount of non-encapsulated fragrance material. This is considered the reference value which represents 100% of perfume leaked from the delivery particle.

This total perfume HS response is compared to the total HS response obtained for a Bead sample containing the same type and amount of encapsulated fragrance material. When these two values are compared to each other the amount of perfume leaked from the delivery particle can be determined through the following equation:

$$\% Perfume Loss after making of Beads ( \% ) = \frac{Total perfume {HS}_{Encapsulated perfume}}{Total perfume {HS}_{Non - encapsulated perfume}}$$

### EXAMPLES

### Example 1

In the following examples, the abbreviations, materials or tradenames correspond to the materials listed in Table 1. The examples are intended to be illustrative in nature and are not intended to be limiting.

TABLE 1
Materials - chitosan

| Trade Name | Company/City | Material |
|---|---|---|
| ChitoClear | Primex EHF, Siglufjordur, Iceland | chitosan |

The di- and/or poly-isocyanates comprise an aromatic moiety. The isocyanates employed have two functional groups: an isocyanate group and an aromatic moiety. For ease of reference, the isocyanate molecules can be subdivided into several classifications.

A first grouping can be on the basis of the presence or absence of an aromatic moiety within the whole molecule; hence the following two classification are defined:
1-isocyanate comprising at least one aromatic moiety.
2-isocyanate not comprising any aromatic moiety.

For convenience, the presence of the aromatic moiety can be further classified as either alpha or beta based on carbon-atom naming. Hence the isocyanate comprising an aromatic moiety can be subdivided.
1. i) isocyanate comprising an alpha-aromatic moiety; and,
1. ii) isocyanate comprising a beta-aromatic moiety.
   For ease of reference, Group 1, i) and ii) classifications are then referred to as:
1. i) alpha-aromatic
1. ii) beta-aromatic
and Group 2 as
2. “non-aromatic”
   This naming convention is reflected in Table 2 below:

TABLE 2
Materials-isocyanates

| Trade | Company/ | | | Classifi- | |
|---|---|---|---|---|---|
| Name | City | Material | Chemical structure | cation | NCO |
| Takenate D-110N | Mitsui Chemicals America, Inc, Rye Brook, NY | polyisocyanate prepolymer; adduct of xylylene diisocyanate | 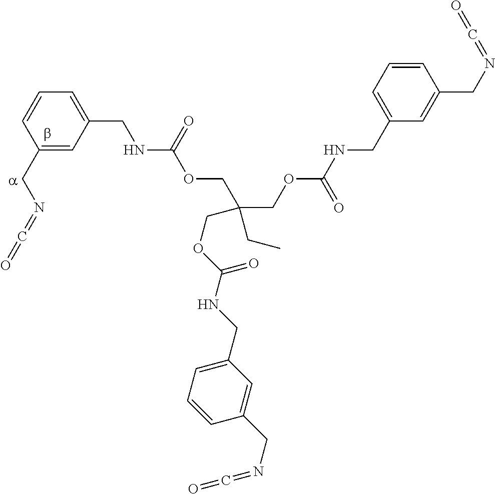 [SMILES: CCC(COC(=O)NCc1cccc(CN=C=O)c1)(COC(=O)NCc1cccc(CN=C=O)c1)COC(=O)NCc1cccc(CN=C=O)c1] | Beta- Aromatic | 15.3% |
| MMRL Mondur MR-Light | Covestro LLC Pittsburgh, PA | polymeric diphenylmethane diisocyanate | 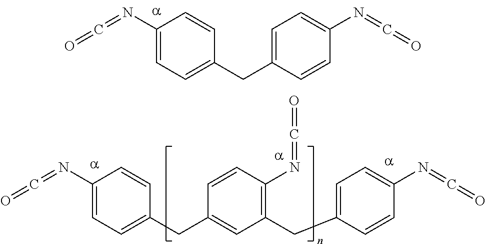 | Alpha- Aromatic | 31.3% |
| Lupranate M20 Isocyanate | BASF, Florham Park, NJ | polymethylene polyphenylpol yisocyanate | 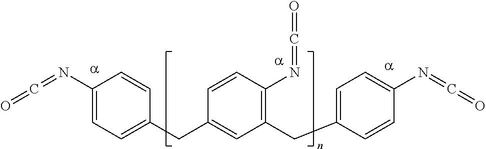 | Alpha- Aromatic | 31.5% |

### Example 2

The data in Table 3 demonstrate that samples made with all beta-aromatic isocyanate (Comparative Example 1) or all alpha-aromatic isocyanate (Comparative Example 2) have the highest level of leakage when formulated into a water-soluble unit dose article, wherein the water-soluble unit dose article comprising a liquid laundry treatment composition, wherein said liquid laundry treatment composition comprised less than 15 wt % of water. When a combination of alpha- and beta-aromatic isocyanates are used according to the present disclosure, a lower level of leakage is observed in said unit dose articles.

TABLE 3
Influence of Alpha-Aromatic and Beta-Aromatic Isocyanates
on Leakage of Delivery Particles in Unit Dose Articles

| | Beta-aromatic Isocyanate | | | Alpha-aromatic Isocyanate | | | Leakage in | |
|---|---|---|---|---|---|---|---|---|
| | | Amount | | | Amount | | Unit Dose | Weighted |
| Example | Name | (g) | % | Name | (g) | % | article % | NCO % |
| Comparative | Takenate | 4.81 | 100 | Mondur | 0 | 0 | 13.5 ± 0.7 | 15.3 |
| Example 1 | D-110N | | | MR-Light | | | | |
| Example 1A | Takenate | 4.55 | 94.6 | Mondur | 0.2 | 5.4 | 9.4 ± 0.4 | 16.2 |
| | D-110N | | | MR-Light | | | | |
| Example 1B | Takenate | 4.08 | 84.8 | Mondur | 0.55 | 15.2 | 7.1 ± 0.1 | 17.7 |
| | D-110N | | | MR-Light | | | | |
| Example 1C | Takenate | 3.61 | 75 | Mondur | 0.9 | 25 | 5.6 ± 0.1 | 19.3 |
| | D-110N | | | MR-Light | | | | |
| Example 1D | Takenate | 2.62 | 65.2 | Mondur | 1.01 | 34 | 2.2 ± 0.6 | 20.7 |
| | D-110N | | | MR-Light | | | | |
| Example 1E | Takenate | 2.08 | 52.5 | Mondur | 1.41 | 47.5 | 2.0 ± 0.1 | 22.9 |
| | D-110N | | | MR-Light | | | | |
| Example 1F | Takenate | 1.54 | 38.75 | Mondur | 1.82 | 61.3 | 2.9 ± 0.1 | 25.1 |
| | D-110N | | | MR-Light | | | | |
| Comparative | Takenate | 0 | 0 | Mondur | 2.97 | 100 | 18.7 ± 0.1 | 31.3 |
| Example 2 | D-110N | | | MR-Light | | | | |

### Example 3

Leakage in Unit Dose article is assessed through according to the “Leakage Procedure” provided in the Test Methods section above.

All samples of Table 4 are made with the same weight concentration 66% for Isocyanate 1 and 34% for Isocyanate 2. As illustrated in Table 4, delivery particles using a combination of aromatic isocyanates according to the present disclosure achieve lower leakage when formulated in water-soluble unit dose articles, wherein the water-soluble unit dose article comprising a liquid laundry treatment composition, wherein said liquid laundry treatment composition comprised less than 15 wt % of water and 1% by weight of the liquid laundry treatment composition of the delivery particle. Delivery particles made with only a combination of a beta-aromatic isocyanate and a non-aromatic isocyanate (Comparative Examples 3, 4, and 5) have a high level of leakage in said unit dose articles.

TABLE 4
Influence of No Aromatic and Aromatic Isocyanates Leakage of Delivery Particles in Unit Dose Articles

| | Isocyanate 1 | | | | Isocyanate 2 | | | | Leakage in |
|---|---|---|---|---|---|---|---|---|---|
| | | Classifi- | % of | Amount | | Classifi- | % of | Amount | Unit Dose |
| Example # | Name | cation | Isocyanate | (g) | Name | cation | Isocyanate | (g) | article % |
| Comparative | Takenate | Beta- | 66 | 3.22 | Wannate | Non- | 34 | 1.24 | 31.3 ± 0.5 |
| example 3 | D-110N | aromatic | | | H1210 | aromatic | | | |
| Comparative | Takenate | Beta- | 66 | 3.22 | Desmodur | Non- | 34 | 1.24 | 15.7 ± 0.1 |
| example 4 | D-110N | aromatic | | | N 3400 | aromatic | | | |
| Comparative | Takenate | Beta- | 66 | 3.22 | Desmodur | Non- | 34 | 1.24 | 21.4 ± 0.2 |
| example 5 | D-110N | aromatic | | | N 3300, | aromatic | | | |
| Example 1D | Takenate | Beta- | 66 | 2.62 | Mondur | Alpha- | 34 | 1.01 | 2.2 ± 0.6 |
| | D-110N | aromatic | | | MR-Light | aromatic | | | |
| Example 1 G | Takenate | Beta- | 66 | 3.22 | Lupranate M20 | Alpha- | 34 | 1.24 | 3.65 ± 0.1 |
| | D-110N | aromatic | | | Isocyanate | aromatic | | | |

### Example 4

Leakage in Unit Dose article is assessed through according to the “Leakage Procedure” provided in the Test Methods section above.

Fabrics are treated by the unit dose article described above according to the Fabric Treatment Method provided in the Test Methods section above (via the “Method to determine headspace concentration above treated fabrics”).

According to the data in Table 5, the comparative example shows no DFO and RFO Headspace benefit, while Example 1A displays significant higher headspace values at DFO and RFO. It is believed that the benefit of Example 1A compared to the comparative example is due to the optimal combination of Beta-aromatic Isocyanate and Alpha-aromatic Isocyanate which leads to a lower Leakage in Unit Dose Article as highlighted in Table 5 which subsequently leads to higher Headspace Concentration above dry and rubbed fabrics.

TABLE 5
Influence of Inventive Delivery Particles on Fabric Headspace Concentration

| | Beta-aromatic Isocyanate | | | Alpha-aromatic Isocyanate | | | | | |
|---|---|---|---|---|---|---|---|---|---|
| | | Amount | | | Amount | | WFO HS | DFO HS | RFO HS |
| Example | Name | (g) | % | Name | (g) | % | [nmol/L] | [nmol/L] | [nmol/L] |
| Comparative | Takenate | 4.81 | 100 | Mondur | 0 | 0 | 18.2 ± 1.3 | 0 ± 0 | 0 ± 0 |
| Example 1 | D-110N | | | MR-Light | | | | | |
| Example 1A | Takenate | 2.62 | 65.2 | Mondur | 1.01 | 34 | 71.7 ± 9.0 | 4.6 ± 0.9 | 8.4 ± 0.7 |
| | D-110N | | | MR-Light | | | | | |

### Example 5

Determining the Amount of Perfume Loss after Making of Laundry Care Particles
Laundry care particles were made according to making method described above (Beads making procedure). Below Table 6 represents Laundry care particles comprising delivery particles according to the present disclosure.

TABLE 6
Fabric enhancer bead composition

| | % Active |
|---|---|
| Ingredients | (wt %) |
| Polyethylene glycol (PLURIOL E8000 from BASF) | 87.26 |
| Cyan 15 dye solution | 0.012 |
| Delivery particles according to the present disclosure | 2.7 |
| Water | To 100 |

The perfume Loss after making of Beads was assessed according to the method “Determining the Amount of Perfume Loss after making of Beads” provided in the Test Methods section above.
Table 7 highlights that Comparative Example 1, which is characterized by a single Beta-aromatic Isocyanate, exhibits the highest amount of Perfume Loss after making of Beads. Moreover, Table 7 demonstrates that by increasing the amount of Alpha-aromatic Isocyanate the perfume loss diminishes till to reach the lowest values around 20% and 40% in Alpha-aromatic Isocyanate weighted concentration.

TABLE 7
Perfume Loss after making of Beads comprising capsules made with different
ratios of Alpha-aromatic isocvanates and Beta-aromatic isocyanates.

| | Beta-aromatic Isocyanates | | | Alpha-aromatic Isocyanate | | | | Perfume Loss |
|---|---|---|---|---|---|---|---|---|
| | | Amount | | | Amount | | Weighted | after making |
| Example | Name | (g) | % | Name | (g) | % | NCO % | of Beads [%] |
| Comparative | Takenate | 4.81 | 100% | Mondur | 0 | 0% | 15.30% | 106.1 ± 1.9 |
| Example 1 | D-110N | | | MR-Light | | | | |
| Example 1A | Takenate | 4.33 | 90% | Mondur | 0.36 | 10% | 16.90% | 76.7 ± 6.9 |
| | D-110N | | | MR-Light | | | | |
| Example 1B | Takenate | 3.85 | 80% | Mondur | 0.72 | 20% | 18.50% | 23.9 ± 2.5 |
| | D-110N | | | MR-Light | | | | |
| Example 1D | Takenate | 3.37 | 70% | Mondur | 1.08 | 30% | 20.10% | 25.3 ± 3.4 |
| | D-110N | | | MR-Light | | | | |
| Example 1E | Takenate | 2.89 | 60% | Mondur | 1.44 | 40% | 21.70% | 19.6 ± 1.7 |
| | D-110N | | | MR-Light | | | | |

Perfume Loss after Beads Processing is assessed according to the method “Determining the Amount of Perfume Loss after Beads Processing” provided in the Test Methods section above.

### Example 6

Population of capsules that have undergone a drying process involving heating to remove the water content.”

Perfume capsules according to present disclosure underwent a spray-drying process as described in the method “Spray-drying Procedure” provided in the Methods section above.

Free Oil after Spray-drying was assessed according to the method “Procedure for Determination of Free Oil after Spray-drying” provided in the Methods section above.

Table 8 highlights that Comparative Example 1, characterized by a single Beta-aromatic Isocyanate, exhibited the highest amount of Free Oil after Spray-drying. Moreover, Table 8 demonstrates that increasing the amount of Alpha-aromatic Isocyanate led to a reduction in Free oil after Spray-drying, reaching the lowest values at approximately 15% and 40% in terms of Alpha-aromatic Isocyanate weighted concentration. Additionally, Table 8 underlines that reducing the Volume Weighted Median Microcapsule Size from 29±4 μm to 16±4 μm and increasing the Shell (%) further contributed to the reduction of Free Oil after Spray-drying to values of 2.9±0.0%.

TABLE 8
Free Oil after Spray-Drying capsules made with different ratios of Alpha-aromatic isocyanates and
Beta-aromatic isocyanates and varying Shell (%) and Volume Weighted Median Microcapsule Size (um).

| | | | | | | | | Volume | | |
|---|---|---|---|---|---|---|---|---|---|---|
| | | | | | | | | Weighted | | |
| | | | | | | | | Median | | |
| | Beta-aromatic Isocyanate | | | Alpha-aromatic Isocyanate | | | | Delivery | | Free Oil after |
| | | Amount | | | Amount | | Weighted | Particle Size | Shell | SprayDrying |
| Example | Name | (g) | % | Name | (g) | % | NCO % | (um) | (%) | [% |
| Comparative | Takenate | 4.81 | 100 | Mondur | 0 | 0 | 15.3 | 29 ± 4 | 13.6 | 21.5 ± 0.3 |
| Example 1 | D-110N | | | MR-Light | | | | | | |
| Example 1A | Takenate | 4.55 | 94.6 | Mondur | 0.2 | 5.4 | 16.2 | 29 ± 4 | 13.6 | 18.6 ± 0.3 |
| | D-110N | | | MR-Light | | | | | | |
| Example 1B | Takenate | 4.08 | 84.8 | Mondur | 0.55 | 15.2 | 17.7 | 29 ± 4 | 13.6 | 6.3 ± 0.1 |
| | D-110N | | | MR-Light | | | | | | |
| Example 1C | Takenate | 3.61 | 75 | Mondur | 0.9 | 25 | 19.3 | 29 ± 4 | 13.6 | 7.7 ± 0.0 |
| | D-110N | | | MR-Light | | | | | | |
| Example 1D | Takenate | 3.22 | 66 | Mondur | 1.24 | 34 | 20.7 | 29 ± 4 | 13.6 | 7.1 ± 0.1 |
| | D-110N | | | MR-Light | | | | | | |
| Example 1G | Takenate | 3.22 | 66 | Mondur | 1.24 | 34 | 20.7 | 16 ± 4 | 13.6 | 4.1 ± 0.1 |
| | D-110N | | | MR-Light | | | | | | |
| Example 1H | Takenate | 3.22 | 66 | Mondur | 1.24 | 34 | 20.7 | 16 ± 4 | 16.7 | 2.9 ± 0.0 |
| | D-110N | | | MR-Light | | | | | | |

The following are example formulations according to the present disclosure;

TABLE 9
Liquid laundry detergent compositions

| | % Active (wt %) | | | |
|---|---|---|---|---|
| | Composition | | | |
| Ingredient | Example 2A | Example 2B | Example 2C | Example 2D |
| Branched Alkyl Sulfate | 0.0 | 5.3 | 0.0 | 5.3 |
| Sodium Lauryl Sulfate | 0.0 | 3.0 | 0.0 | 3.0 |
| Linear alkylbenzene sulfonate | 18.0 | 5.0 | 6.0 | 5.0 |
| AE₃S Ethoxylated alkyl sulphate | 5.0 | 0.0 | 1.3 | 0.0 |
| with an average degree of | | | | |
| ethoxylation of 3 | | | | |
| C₁₂₋₁₅AES Ethoxylated alkyl | 0.0 | 3.0 | 1.4 | 0.0 |
| sulphate with an average degree | | | | |
| of ethoxylation of 2.5¹ | | | | |
| Amine oxide | 0.7 | 1.0 | 0.4 | 0.8 |
| C₁₂₋₁₄ alkyl ethoxylate (EO7) | 8.4 | 0.0 | 12.9 | 5.0 |
| C₁₂₋₁₄ alkyl ethoxylate (EO9) | 0.0 | 8.7 | 0.0 | 3.7 |
| C₁₂₋₁₅ alkyl ethoxylate (EO7) | 0.0 | 2.7 | 0.0 | 2.7 |
| Citric acid | 2.9 | 2.3 | 0.7 | 2.3 |
| Palm kernel fatty acid | 0.0 | 1.0 | 0.0 | 1.0 |
| Topped kernel fatty acid | 2.9 | 0.0 | 2.3 | 0.0 |
| Mannanase | 0.0017 | 0.0017 | 0.0017 | 0.0017 |
| Pectawash | 0.00342 | 0.00342 | 0.00342 | 0.00342 |
| Amylase | 0.00766 | 0.00766 | 0.00766 | 0.00766 |
| Protease | 0.07706 | 0.07706 | 0.07706 | 0.07706 |
| Nuclease³ | 0.010 | 0.01 | 0.01 | 0.01 |
| Sodium tetraborate | 0.0 | 1.7 | 0.0 | 1.7 |
| MEA-Boric Acid Salt | 0.0 | 0.0 | 0.8 | 0.0 |
| Calcium/sodium formate | 0.0 | 0.04 | 0.01 | 0.04 |
| Sodium/Calcium Chloride | 0.04 | 0.02 | 0.03 | 0.02 |
| Ethoxylated polyethyleneimine² | 0.0 | 2.0 | 1.1 | 2.0 |
| Amphiphilic graft copolymer | 1.5 | 0.0 | 0.0 | 0.0 |
| Ethoxylated-Propoxylated | 0.0 | 2.0 | 0.8 | 2.0 |
| polyethyleneimine | | | | |
| Zwitterionic polyamine | 0.5 | 0.0 | 0.0 | 0.0 |
| Nonionic polyester terephthalate | 1.0 | 1.0 | 1.0 | 1.0 |
| Graft polymer of the present | 1.0 | 2.0 | 1.5 | 2.5 |
| disclosure | | | | |
| DTPA | 0.0 | 0.1 | 0.2 | 0.1 |
| EDDS | 0.1 | 0.0 | 0.0 | 0.0 |
| GLDA | 0.4 | 0.3 | 0.1 | 0.0 |
| MGDA | 0.2 | 0.0 | 0.0 | 0.5 |
| Diethylene triamine penta(methyl | 1.1 | 0.0 | 0.0 | 0.0 |
| phosphonic) acid (DTPMP) | | | | |
| Fluorescent Brightener⁸ | 0.06 | 0.22 | 0.03 | 0.15 |
| Ethanol | 0.7 | 1.9 | 0.0 | 1.9 |
| propylene glycol | 5.5 | 5.5 | 0.33 | 5.5 |
| Sorbitol | 0.01 | 0.01 | 0.0 | 0.01 |
| Monoethanolamine | 0.2 | 0.2 | 0.6 | 0.2 |
| DETA | 0.1 | 0.08 | 0.0 | 0.08 |
| Antioxidant 1 | 0.0 | 0.1 | 0.1 | 0.1 |
| Antioxidant 2 | 0.1 | 0.0 | 0.0 | 0.0 |
| Hygiene Agent | 0.0 | 0.0 | 0.05 | 0.0 |
| NaOH | 4.7 | 4.7 | 1.1 | 4.7 |
| NaCS | 3.2 | 1.7 | 3.2 | 1.7 |
| Hydrogenated Castor Oil | 0.2 | 0.1 | 0.12 | 0.1 |
| Aesthetic dye | 0.10 | 0.01 | 0.006 | 0.01 |
| Leuco dye | 0.05 | 0.01 | 0.0 | 0.01 |
| Perfume | 2.0 | 1.3 | 0.5 | 1.3 |
| Delivery particle according | 0.5 | 0.05 | 0.1 | 0.05 |
| to the present disclosure | | | | |
| Silicone antifoam⁷ | 0.02 | 0.01 | 0.0 | 0.01 |
| Phenyloxyethanol | 0.002 | 0.01 | 0.0 | 0.01 |
| Hueing dye | 0.01 | 0.1 | 0.05 | 0.1 |
| Water & misc. | To Balance | To Balance | To Balance | To Balance |

Description of superscript numbers:
¹C₁₂₋₁₅EO_{2.5}S AlkylethoxySulfate where the alkyl portion of AES includes, on average, from about 13.9 to 14.6 carbon atoms
²PE-20 commercially available from BASF
³Nuclease enzyme is as claimed in co-pending European application 19219568.3
4. Antioxidant 1 is 3,5-bis(1,1-dimethylethyl)-4-hydroxybenzenepropanoic acid, methyl ester [6386-38-5]
5. Antioxidant 2 is Tinogard TS commercially available from BASF
6. Hygiene Agent is agent is Tinosan HP 100 commercially available from BASF
⁷Dow Corning supplied antifoam blend 80-92% ethylmethyl, methyl(2-phenyl propyl)siloxane; 5-14% MQ Resin in octyl stearate a 3-7% modified silica.
⁸Fluorescent Brightener is disodium 4,4′-bis{[4-anilino-6-morpholino-s-triazin-2-yl]-amino}-2,2′-stilbenedisulfonate or 2,2′-([1,1′-Biphenyl]-4,4′-diyldi-2,1-ethenediyl)bis-benzenesulfonic acid disodium salt.

TABLE 10
Unit dose article composition

| | % Active (wt %) |
|---|---|
| | Composition |
| Ingredient | Example 3A |
| Fatty alcohol ethoxylate non-ionic surfactant, | 3.5 |
| C₁₂₋₁₄average degree of ethoxylation of 7 | |
| Linear C₁₁₋₁₄ alkylbenzene sulphonate | 27.3 |
| C₁₂₋₁₄ AE₃S Ethoxylated alkyl sulphate with | 11.07 |
| an average degree of ethoxylation of 3 | |
| Citric acid | 0.7 |
| Palm Kernel Fatty acid | 5.4 |
| Protease enzyme | Present |
| Amylase enzyme | Present |
| Xyloglucanase enzyme | Present |
| Mannanase enzyme | Present |
| Nuclease enzyme¹ | Present |
| Ethoxylated polyethyleneimine² | 1.6 |
| Amphiphilic graft copolymer³ | 3.2 |
| Zwitterionic polyamine⁴ | 1.9 |
| HEDP chelant | 2.3 |
| Brightener 49 | 0.3 |
| Silicone anti-foam | 0.3 |
| 1,2-PropaneDiol | 13.0 |
| Glycerin | 5.5 |
| DPG (DiPropyleneGlycol) | 0.001 |
| Sorbitol | 0.1 |
| Monoethanolamine | 10.53 |
| K₂SO₃ | 0.15 |
| MgCl₂ | 0.3 |
| Sodium formate | 0.1 |
| water | 10.6 |
| Hydrogenated castor oil | 0.1 |
| Perfume | 1.0 |
| Delivery particle according | 1.0 |
| to the present disclosure | |
| Aesthetic dye & misc. | To Balance |
| (preservatives, salts, . . . ) | |

Description of superscript numbers:
¹Nuclease enzyme is as claimed in co-pending European application 19219568.3
²Lutensol FP620 ex BASF - ethoxylated polyethyleneimine (PEI600 EO20)
³polyethylene glycol graft polymer comprising a polyethylene glycol backbone (Pluriol E6000) and hydrophobic vinyl acetate side chains, comprising 40% by weight of the polymer system of a polyethylene glycol backbone polymer and 60% by weight of the polymer system of the grafted vinyl acetate side chains
⁴Lutensit Z96 (zwitterionic polyamine ex BASF - zwitterionic hexamethylene diamine according to below formula: 100% quaternized and about 40% of the polyethoxy (EO24) groups are sulfonated).

TABLE 11
Laundry granular detergent composition

| | % Active (wt %) |
|---|---|
| | Composition |
| Ingredient (wt %) | Example 4A |
| Anionic detersive surfactant (such as alkyl | from 8 to 15 |
| benzene sulphonate, alkyl ethoxylated sulphate | |
| and mixtures thereof) | |
| Non-ionic detersive surfactant (such as alkyl | from 0.1 to 4 |
| ethoxylated alcohol) | |
| Cationic detersive surfactant (such as | from 0 to 4 |
| quaternary ammonium compounds) | |
| Other detersive surfactant (such as zwiterionic | from 0 to 4 |
| detersive surfactants, amphoteric surfactants | |
| and mixtures thereof) | |
| Carboxylate polymer (such as co-polymers | from 0.1 to 4 |
| of maleic acid and acrylic acid and/or | |
| carboxylate polymers comprising ether | |
| moieties and sulfonate moieties) | |
| Polyethylene glycol polymer (such as a | from 0 to 4 |
| polyethylene glycol polymer comprising | |
| polyvinyl acetate side chains) | |
| Polyester soil release polymer (such as | from 0 to 2 |
| Repel-o-tex and/or Texcare polymers) | |
| Cellulosic polymer (such as carboxymethyl | from 0.5 to 2 |
| cellulose, methyl cellulose and combinations | |
| thereof) | |
| Graft polymer of the present disclosure | From 0.1 to 4 |
| Other polymer (such as polymers based on | from 0 to 4 |
| polysaccharide) | |
| Zeolite builder and phosphate builder (such | from 0 to 4 |
| as zeolite 4A and/or sodium tripolyphosphate) | |
| Other co-builder (such as sodium citrate | from 0 to 3 |
| and/or citric acid) | |
| Carbonate salt (such as sodium carbonate | from 0 to 20 |
| and/or sodium bicarbonate) | |
| Silicate salt (such as sodium silicate) | from 0 to 10 |
| Filler (such as sodium sulphate and/or bio-fillers) | from 10 to 70 |
| Source of hydrogen peroxide (such as sodium | from 0 to 20 |
| percarbonate) | |
| Bleach activator (such as | from 0 to 8 |
| tetraacetylethylene diamine (TAED) and/or | |
| nonanoyloxybenzenesulphonate (NOBS)) | |
| Bleach catalyst (such as oxaziridinium-based | from 0 to 0.1 |
| bleach catalyst and/or transition metal bleach | |
| catalyst) | |
| Other bleach (such as reducing bleach and/or | from 0 to 10 |
| pre-formed peracid) | |
| Photobleach (such as zinc and/or aluminium | from 0 to 0.1 |
| sulphonated phthalocyanine) | |
| Chelant (such as ethylenediamine-N′N′-disuccinic | from 0.2 to 1 |
| acid (EDDS) and/or hydroxyethane diphosphonic | |
| acid (HEDP)) | |
| Hueing agent (such as direct violet 9, 66, 99, | from 0 to 1 |
| acid red 50, solvent violet 13 and any combination | |
| thereof) | |
| Brightener (C.I. fluorescent brightener 260 or | from 0.1 to 0.4 |
| C.I. fluorescent brightener 351) | |
| Protease (such as Savinase, Savinase Ultra, | from 0.1 to 0.4 |
| Purafect, FN3, FN4 and any combination thereof) | |
| Amylase (such as Termamyl, Termamyl ultra, | from 0 to 0.2 |
| Natalase, Optisize, Stainzyme, Stainzyme Plus | |
| and any combination thereof) | |
| Cellulase (such as Carezyme and/or Celluclean) | from 0 to 0.2 |
| Lipase (such as Lipex, Lipolex, Lipoclean | from 0 to 1 |
| and any combination thereof) | |
| Other enzyme (such as xyloglucanase, cutinase, | from 0 to 2 |
| pectate lyase, mannanase, bleaching enzyme) | |
| Fabric softener (such as montmorillonite clay | from 0 to 15 |
| and/or polydimethylsiloxane (PDMS)) | |
| Flocculant (such as polyethylene oxide) | from 0 to 1 |
| Suds suppressor (such as silicone and/or | from 0 to 4 |
| fatty acid) | |
| Perfume | from 0.1 to 1 |
| Delivery particle according to the present | from 0.1 to 1 mi |
| disclosure | |
| Aesthetics (such as coloured soap rings | from 0 to 1 |
| and/or coloured speckles/noodles) | |
| Misc. | To Balance |

TABLE 12
Water-soluble flexible porous solid sheet compositions

| | % Active (wt %) | | | | | | | | |
|---|---|---|---|---|---|---|---|---|---|
| | Composition | | | | | | | | |
| | Example | Example | Example | Example | Example | Example | Example | Example | Example |
| Ingredient | 5A | 5B | 5C | 5D | 5E | 5F | 5G | 5H | 5I |
| Polyvinyl Alcohol (with a | 21 | 23.69 | 18 | 21 | 23.5 | 10.98 | 28.1 | 20 | 20 |
| degree of polymerization of | | | | | | | | | |
| about 1700) | | | | | | | | | |
| Polyvinyl Alcohol (with a | — | — | 6 | — | — | 3.66 | — | — | — |
| degree of polymerization of | | | | | | | | | |
| about 500) | | | | | | | | | |
| Glycerin | 3 | 9.51 | 3.5 | 3 | 9.4 | 2.14 | 9.6 | 9 | 9 |
| Linear Alkylbenzene Sulfonate | 53 | — | 40 | — | — | 24.4 | — | 41.77 | — |
| Sodium Lauryl Sulfate | — | 32.89 | — | — | — | — | — | — | — |
| Sodium Laureth-1 Sulfate | — | — | — | — | 38.5 | — | — | — | — |
| Sodium Laureth-3 Sulfate | 10 | 10.42 | 4.6 | 10 | 4.4 | 2.81 | — | 12 | — |
| C₁₂₋₁₄ Ethoxylated Alcohol | 10 | — | 16 | 10 | — | 31.52 | — | — | — |
| (average EO 7 or 9) | | | | | | | | | |
| C₁₀₋₁₆ Alkyl Ether Sulfate | — | — | — | — | — | — | — | — | 43.92 |
| (average EO 0.6) | | | | | | | | | |
| Sodium Lauroamphoacetate | — | 17.28 | — | — | 17.1 | — | 11.3 | — | — |
| Sodium Trideceth Sulfates with | — | — | — | 53 | — | — | — | — | — |
| a weight average degree of | | | | | | | | | |
| ethoxylation of about 2 (ST₂S) | | | | | | | | | |
| Sodium Lauraimidopropyl | — | — | — | — | — | — | 28.1 | — | — |
| Betaine | | | | | | | | | |
| Lauramine Oxide | — | — | — | — | — | — | — | — | 9.85 |
| Sodium Lauroyl Methyl | — | — | — | — | — | — | 16.9 | — | — |
| Isethionate | | | | | | | | | |
| Ethoxylated Polyethyleneimine | — | — | 1.5 | — | — | 0.92 | — | 2 | 2 |
| Guar Hydroxypropyltrimonium | — | — | — | — | 1.2 | — | — | — | — |
| Chloride | | | | | | | | | |
| Fatty acids or salts thereof | — | — | 2.07 | — | — | 1.26 | — | 2 | 2 |
| Citric Acid | — | 3.21 | — | — | 2.9 | — | — | — | — |
| Delivery particle according to | 1 | 1 | 1 | 2 | 2 | 3 | 3 | 5 | 5 |
| the present disclosure | | | | | | | | | |
| Perfume | — | — | — | — | — | 13.3 | — | — | — |
| | | | | | | nea3 | | | |
| Zeolite | — | — | 0.95 | — | — | 0.58 | — | 1 | 1 |
| Dipropylene Glycol | — | — | — | — | — | 3.9 | — | — | — |
| Denatonium Benzoate | — | — | 0.04 | — | — | 0.02 | — | — | — |
| Water | To | To | To | To | To | To | To | To | To |
| | Balance | Balance | Balance | Balance | Balance | Balance | Balance | Balance | Balance |

TABLE 13
Water-soluble flexible porous solid sheet compositions

| | % Active (wt %) | | | | | |
|---|---|---|---|---|---|---|
| | Composition | | | | | |
| | Example | Example | Example | Example | Example | Example |
| Ingredient | 5J | 5K | 5L | 5M | 5N | 5O |
| [symbol] yvinyl Alcohol | 20 | 25.3 | 22.3 | 24.7 | 25 | 25 |
| [symbol] th a degree of | | | | | | |
| [symbol] ymerization of | | | | | | |
| [symbol] ut 1700) | | | | | | |
| Polyvinyl | — | — | — | — | — | — |
| Alcohol (with | | | | | | |
| a degree of | | | | | | |
| polymerization | | | | | | |
| of about 500) | | | | | | |
| Glycerin | 20 | 35.4 | 34.4 | 34.6 | 33.8 | 34.7 |
| C₁₂₋₁₄ | 25.1 | — | — | — | — | — |
| Ethoxylated | | | | | | |
| Alcohol | | | | | | |
| DEEDMAC | — | 25.9 | — | 25.4 | 20 | 23 |
| HTQ | — | — | 31.1 | — | — | — |
| Ethanaminium, | 25 | — | — | — | — | — |
| 2-hydroxy-N- | | | | | | |
| (2- | | | | | | |
| hydroxyethyl)- | | | | | | |
| N,N-dimethyl- | | | | | | |
| [symbol] , esters with | | | | | | |
| C16-18 and | | | | | | |
| C18-unsatd. | | | | | | |
| fatty acids, | | | | | | |
| chlorides | | | | | | |
| Lauryl | — | — | — | — | 5 | 2 |
| trimethyl | | | | | | |
| ammonium | | | | | | |
| chloride | | | | | | |
| Starch | — | 3.4 | 2.2 | 3.3 | 2.5 | 3.3 |
| Silica | — | — | — | — | 2.5 | — |
| 2-Propanol | 2.8 | — | — | — | — | — |
| Citric Acid | 4.1 | — | — | — | — | — |
| Perfume | 0.1-12 | 0.2-8 | 1-5 | 2 | 2 | 2 |
| delivery | | | | | | |
| particles | | | | | | |
| according to | | | | | | |
| the present | | | | | | |
| disclosure | | | | | | |
| Water | To | To | To | To | To | To |
| | Balance | Balance | Balance | Balance | Balance | Balance |

[symbol]

indicates data missing or illegible when filed

TABLE 14
Fibrous water-soluble unit dose articles

| | % Active (wt %) | | | |
|---|---|---|---|---|
| | Composition | | | |
| | Example | Example | Example | Example |
| Ingredient | 6A | 6B | 6C | 6D |
| NaAS (from fiber) | 3.63% | 2.27% | 3.63% | 3.52% |
| Genapol T250 | 4.88% | 5.08% | 2.44% | 2.37% |
| (NI68-25)¹ | | | | |
| NaAE1S (SLE1S, | 18.94% | 19.72% | 9.47% | 9.19% |
| from particle) | | | | |
| NaLAS (from fiber | 16.91% | 16.05% | 48.52% | 47.07% |
| & particle) | | | | |
| PE20 (from particle) | 7.28% | 7.59% | 3.64% | 3.53% |
| Sodium Carbonate | 9.82% | 10.22% | 4.91% | 4.76% |
| (from particle) | | | | |
| Sodium Sulfate | 0.34% | 0.34% | 0.21% | 0.20% |
| (from particle) | | | | |
| Silica | 10.93% | 11.38% | 5.47% | 5.30% |
| (from particle) | | | | |
| Trilon M Granule | 1.57% | 1.64% | 0.79% | 0.76% |
| SG³ (MGDA) | | | | |
| AcuSol 455⁴ (from | 4.77% | 4.97% | 2.39% | 2.31% |
| particle) | | | | |
| Zeolite (from | 0.44% | 0.46% | 0.22% | 0.21% |
| Particle) | | | | |
| Citrate (trisodium) | 2.09% | 2.18% | 1.05% | 1.02% |
| PVOH 505⁵ (from | 4.97% | 4.85% | 4.97% | 4.82% |
| fiber) | | | | |
| PEOn10 (from fiber) | 0.43% | 0.35% | 0.43% | 0.41% |
| PEOn60k (from | 0.07% | 0.05% | 0.07% | 0.06% |
| fiber) | | | | |
| NaOH | 0.23% | 0.22% | 0.17% | 0.16% |
| (from particle) | | | | |
| Perfume | 1.59% | 1.59% | 1.59% | 2.49% |
| Delivery particle | 2.42% | 2.42% | 2.42% | 2.42% |
| according to the | | | | |
| present disclosure | | | | |
| AF8017⁶ Suds | 1.40% | 1.40% | 1.40% | 1.36% |
| suppressor | | | | |
| Savinase 32L⁷ | 2.80% | 2.80% | 2.80% | 2.72% |
| (89.6 mg/g) | | | | |
| Non-Ionic | 0.06% | 0.06% | 0.06% | 0.05% |
| Surfactant 24-9 | | | | |
| Stainzyme Plus 24L⁸ | 1.31% | 1.31% | 1.31% | 1.27% |
| (26.2 mg/g) | | | | |
| Vividase (48.1 mg/g) | 0.00% | 0.00% | 0.00% | 0.72% |
| Preferenz P2083⁹ | 0.00% | 0.00% | 0.00% | 0.86% |
| (145.3 mg/g) | | | | |
| Brightener 49 | 0.19% | 0.19% | 0.19% | 0.19% |
| Water & misc. | To | To | To | To |
| | Balance | Balance | Balance | Balance |

Description of superscript numbers:
¹Genapol T250 is a nonionic surfactant is commercially available from Clariant.
2. PE-20 is an ethoxylated polyethylene imine commercially available from BASF.
³Trilon M SG is Methylglycinediacetic acid chelant commercially available from BASF.
⁴AcuSol 455 is a homopolymer of acrylic acid commercially available from Dow.
⁵Celvol PVOH 505 Mw 40,000-50,000 g/mol, 72-75% hydrolyzed, available from Kuraray America
⁶Suds suppressor is AF-8017 commercially available from Dow.
⁷Savinase is a protease commercially available from Novozymes
⁸Stainzyme is an amylase commercially available from Novozymes
⁹Vividase is an amylase commercially available from IFF
10. Preferenz is a protease commercially available from IFF

TABLE 15
Fabric enhancer beads compositions

| | % Active (wt %) | | | | | | | | |
|---|---|---|---|---|---|---|---|---|---|
| | Composition | | | | | | | | |
| | Example | Example | Example | Example | Example | Example | Example | Example | Example |
| Ingredient | 11A | 11B | 11C | 11D | 11E | 11F | 11G | 11H | 11I |
| Polyethylene glycol | 60 | 80 | — | 55 | 75 | — | 89.26 | 87.27 | 82.26 |
| having a weight | | | | | | | | | |
| average molecular | | | | | | | | | |
| weight of 9000 | | | | | | | | | |
| Cyan 15 dye | — | — | — | — | — | — | 0 | 0 | 0.012 |
| solution | | | | | | | | | |
| Perfume | — | — | — | 7.5 | 5 | 6 | 7.5 | 7.5 | 8 |
| Modified starch, | — | — | 17 | — | — | 15.74 | — | — | — |
| maltodextrin M100 | | | | | | | | | |
| Sugar alcohol | — | — | 54 | — | — | 50 | — | — | — |
| polyol selected | | | | | | | | | |
| from the group | | | | | | | | | |
| consisting of | | | | | | | | | |
| mannitol, maltitol, | | | | | | | | | |
| erythritol, isomalt, | | | | | | | | | |
| sorbitol, and | | | | | | | | | |
| mixtures thereof | | | | | | | | | |
| Delivery particle | 2 | 3 | 2.5 | 2 | 3 | 2.5 | 0.7 | 2.7 | 2.7 |
| according to the | | | | | | | | | |
| present disclosure | | | | | | | | | |
| Starch and or | 35 | 14 | 9.5 | 35 | 15 | 9.5 | — | — | — |
| sodium sulfate | | | | | | | | | |
| Water | To | To | To | To | To | To | To | To | To |
| | Balance | Balance | Balance | Balance | Balance | Balance | Balance | Balance | Balance |

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any composition or method disclosed or claimed herein or that it alone, or in any combination with any other reference or references, teaches, suggests or discloses any such composition or method. Further, to the extent that any meaning or definition of a term in this document conflicts with any meaning or definition of the same term in a document incorporated by reference, the meaning or definition assigned to that term in this document shall govern.

While particular embodiments of the present disclosure have been illustrated and described, it would be obvious to those skilled in the art that various other changes and modifications can be made without departing from the spirit and scope of the present disclosure. It is therefore intended to cover in the appended claims all such changes and modifications that are within the scope of the present disclosure.

What is claimed is:

1. A laundry treatment composition comprising a delivery particle wherein the delivery particle comprises a core and shell surrounding the core, and
wherein the core comprises a perfume,
wherein the shell comprises a polymeric material that is the reaction product of chitosan
wherein the reaction product of chitosan is derived from an aqueous phase, and a cross-linking agent,
wherein the cross-linking agent comprises an isocyanate component, the isocyanate component comprising a mixture of two or more di- and/or poly-isocyanates, derived from an oil phase, the di- and/or poly-isocyanates each comprising an aromatic moiety; and,
wherein the mixture of di- and/or poly-isocyanates comprising an aromatic moiety comprises at least one alpha-aromatic isocyanate and at least one beta-aromatic isocyanate.

2. The composition according to claim 1, wherein the weighted % NCO of the di- and/or poly-isocyanates comprising an aromatic moiety within the isocyanate component is from about 15 to about 32%, and wherein;
the % NCO of Isocyanate compounds is calculated as below Equation:
$$\% NCO = \frac{Number of NCO groups \cdot MW NCO group}{MW Isocyanate compound}$$
wherein, Number of isocyanate groups (NCO groups) is the count of isocyanate groups present in the compound, MW NCO group is the molecular weight of a single NCO group, MW Isocyanate compound is the molecular weight of the entire isocyanate compound, excluding any solvent or other substances that may be mixed with the isocyanate.

2. The composition according to claim 1, wherein the mass percent of the alpha-aromatic isocyanate in the isocyanate component is from about 1% to about 99% by weight.

3. The composition according to claim 1, wherein the mass percent of the beta-aromatic isocyanate in the isocyanate component is from about 1% to about 99% by weight.

4. The composition according to claim 1, wherein the alpha-aromatic isocyanate is selected from the group consisting of: 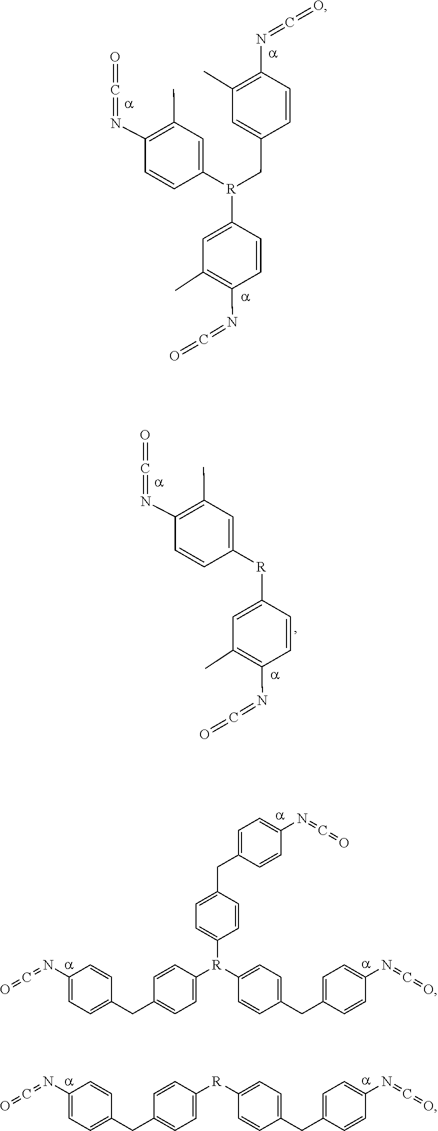
or a mixture thereof,
wherein, R is a biuret, a uretdione, an isocyanurate, a polyol, a polyol having a urethane group, a urea, a polyamine, a polyamine having a urea group, a polyacid with an anhydride group, a poly-isocyanate comprising a biuret, a poly-isocyanate comprising a uretdione, or a polyisocyanate comprising an isocyanurate.

5. The composition according to claim 4, wherein the alpha-aromatic isocyanate is selected from the group consisting of: 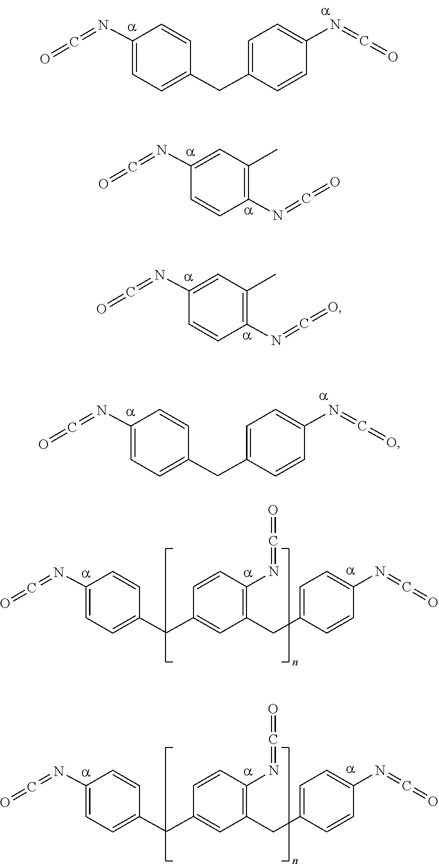
wherein n is an integer from 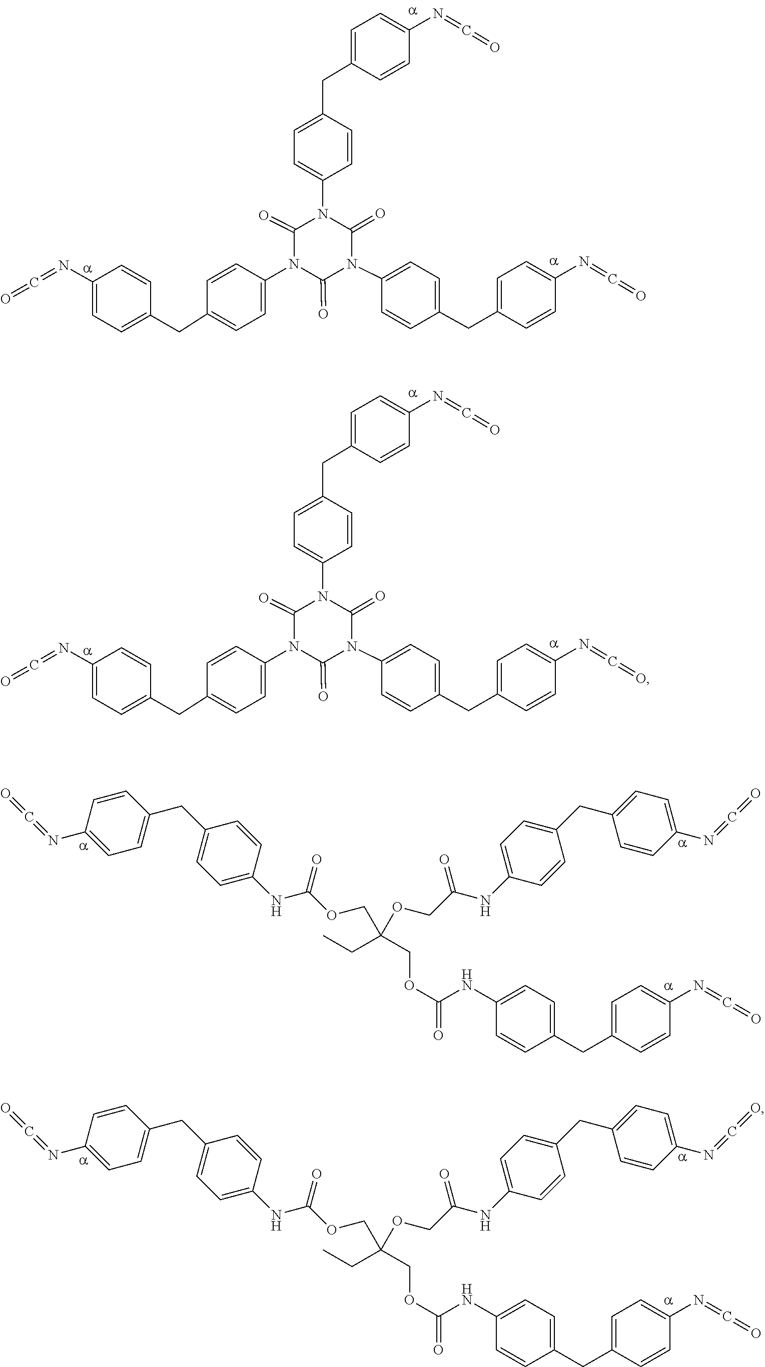 [SMILES: O=C=Nc1ccc(Cc2ccc(-n3c(=O)n(-c4ccc(Cc5ccc(N=C=O)cc5)cc4)c(=O)n(-c4ccc(Cc5ccc(N=C=O)cc5)cc4)c3=O)cc2)cc1 ; O=C=Nc1ccc(Cc2ccc(-n3c(=O)n(-c4ccc(Cc5ccc(N=C=O)cc5)cc4)c(=O)n(-c4ccc(Cc5ccc(N=C=O)cc5)cc4)c3=O)cc2)cc1 ; CCC(COC(=O)Nc1ccc(Cc2ccc(N=C=O)cc2)cc1)(COC(=O)Nc1ccc(Cc2ccc(N=C=O)cc2)cc1)OCC(=O)Nc1ccc(Cc2ccc(N=C=O)cc2)cc1 ; CCC(COC(=O)Nc1ccc(Cc2ccc(N=C=O)cc2)cc1)(COC(=O)Nc1ccc(Cc2ccc(N=C=O)cc2)cc1)OCC(=O)Nc1ccc(Cc2ccc(N=C=O)cc2)cc1] 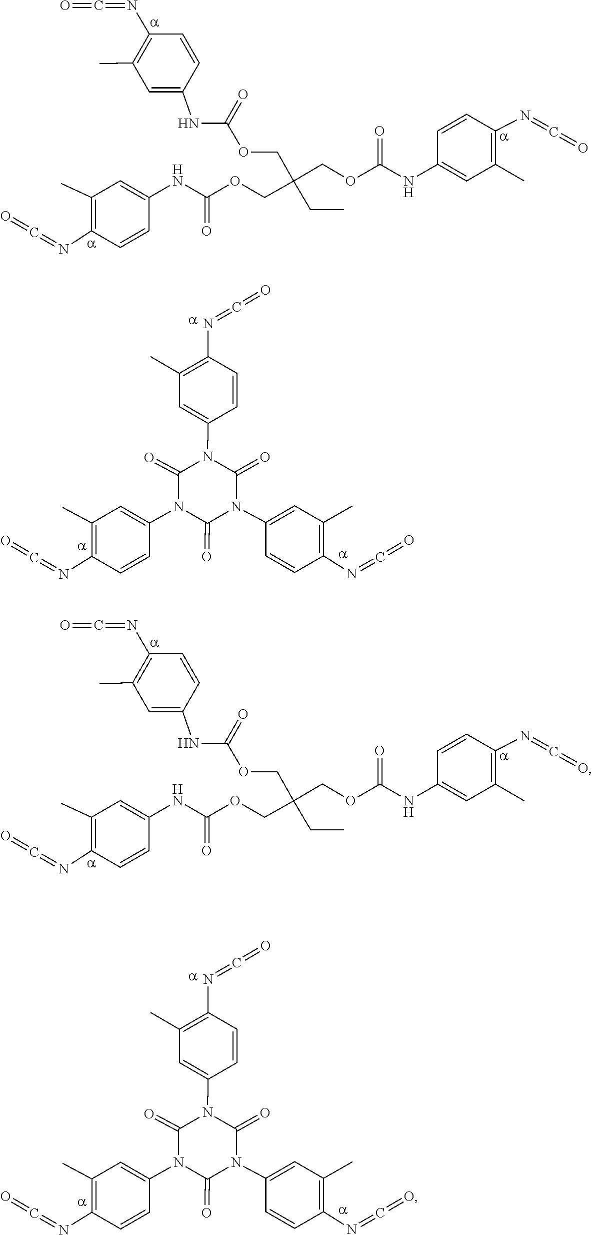 [SMILES: CCC(COC(=O)Nc1ccc(N=C=O)c(C)c1)(COC(=O)Nc1ccc(N=C=O)c(C)c1)COC(=O)Nc1ccc(N=C=O)c(C)c1 ; Cc1cc(-n2c(=O)n(-c3ccc(N=C=O)c(C)c3)c(=O)n(-c3ccc(N=C=O)c(C)c3)c2=O)ccc1N=C=O ; CCC(COC(=O)Nc1ccc(N=C=O)c(C)c1)(COC(=O)Nc1ccc(N=C=O)c(C)c1)COC(=O)Nc1ccc(N=C=O)c(C)c1 ; Cc1cc(-n2c(=O)n(-c3ccc(N=C=O)c(C)c3)c(=O)n(-c3ccc(N=C=O)c(C)c3)c2=O)ccc1N=C=O]
or a mixture thereof.

6. The composition according to claim 5, wherein the alpha-aromatic isocyanate is selected from the group consisting of toluene diisocyanate, methylene diphenyl diisocyanate, polymeric methylene diphenyl diisocyanate, naphthalene diisocyanate, phenylene diisocyanate, isomers thereof, adducts thereof, and combinations thereof.

7. The composition according to claim 1, wherein the beta-aromatic isocyanate is selected from the group consisting of: 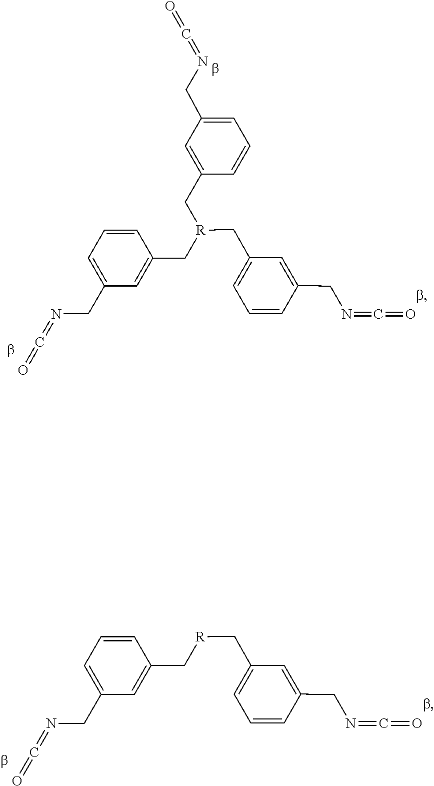
or a mixture thereof, wherein, R is a biuret, a uretdione, a isocyanurate, a polyol, a polyol having a urethane group, a urea, a polyamine, a polyamine having a urea group, a polyacid with an anhydride group, a poly-isocyanate comprising a biuret, a poly-isocyanate comprising a uretdione, or a polyisocyanate comprising an isocyanurate.

8. The composition according to claim 7, wherein the beta-aromatic isocyanate selected from the group consisting of: 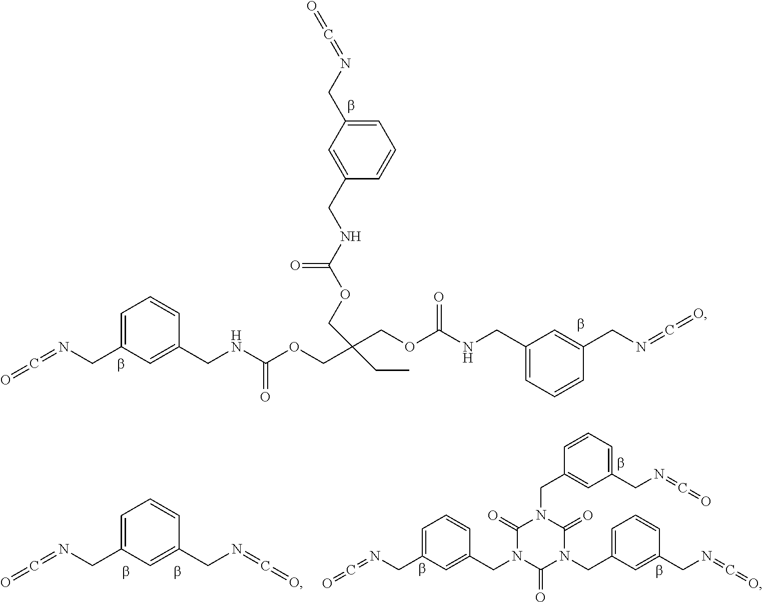
or a mixture thereof.

9. The composition according to claim 8, wherein the beta-aromatic isocyanate is selected from the group consisting of xylylene diisocyanate, trimethylolpropane adducts of xylylene diisocyanate, tetramethylxylidene diisocyanate, isomers thereof, adducts thereof, and combinations thereof.

10. The composition according to claim 1, wherein the isocyanate component comprises at least two di- and/or poly-isocyanates selected from methylenediphenyl diisocyanate, polymeric methylenediphenyl isocyanate, and a trimethylol propane-adduct of xylylene diisocyanate or a mixture thereof.

11. The composition according to claim 1, wherein the chitosan, is characterized by a weight average molecular weight of from about 100 kDa to about 80,000 kDa.

12. The composition according to claim 1, wherein the ratio of the cross-linking agent to chitosan, based on weight, is about 79:21 to about 10:90.

13. The composition according to claim 1, wherein the core-shell encapsulate has a ratio of core to shell of at least about 75:25, on the basis of weight.

14. The composition according to claim 1, wherein the perfume comprises perfume raw materials characterized by a logP of from about about 2.5 to about about 4.5

15. The composition according to claim 1, wherein the delivery particles have a median particle size of from about 1 to 200 microns.

16. The composition according to any of the preceding claims, wherein capsules are Spray-Dried, wherein the delivery particles have a median particle size of from about 1 to 200 microns.

17. The composition according to claim 1, wherein the treatment composition is a laundry detergent composition, a laundry fabric enhancer composition, a laundry fragrance boosting composition or a mixture thereof.

18. The composition according to claim 1, wherein the treatment composition is liquid, a gel, a powder, or a mixture thereof.

19. The composition according to claim 1, wherein the treatment composition is in the form of a unitized dose, wherein the unitized dose could be a unit dose article comprising one or more chambers defined by a water-soluble film or a water-soluble non-woven and in which the laundry treatment composition is contained within said one of more chambers, or wherein the unit dose article is in the form of a non-woven article comprising a plurality of fibres and wherein the laundry treatment composition is contained within and/or between the fibres.

20. The composition according to claim 1, wherein the composition comprises;
a. less than about 20% or even less than about 15% by weight of the composition of water;
b. between about 15% and about 70%, or even between about 20% and about 65% by weight of the composition of a surfactant, wherein the surfactant is selected from an anionic surfactant, a non-ionic surfactant, a cationic surfactant or a mixture thereof;
c. or a mixture thereof.
